(19) United States
(12) Patent Application Publication
(10) Pub. No.: US 2024/0356062 A1
(43) Pub. Date: Oct. 24, 2024

(54) COMPOSITE WITH CONFORMAL GRAPHENE COATINGS, FABRICATING METHODS AND APPLICATIONS OF SAME

(71) Applicant: NORTHWESTERN UNIVERSITY, Evanston, IL (US)

(72) Inventors: Mark C. Hersam, Wilmette, IL (US); Kyu-Young Park, Pohang-si, Gyeongsangbuk-do (KR)

(21) Appl. No.: 18/683,549

(22) PCT Filed: Aug. 16, 2022
(86) PCT No.: PCT/US2022/040396

§ 371 Date: Feb. 14, 2024

Related U.S. Application Data
Application No. PCT/US2022/040396 is a continuation-in-part of application No. 17/369,058, filed on Jul. 7, 2021, now Pat. No. 11,876,168.
(63) Continuation-in-part of application No. PCT/US21/44873, filed on Aug. 6, 2021.
Application No. PCT/US21/44873 is a continuation of application No. 15/906,776, filed on Feb. 27, 2018, now Pat. No. 11,088,392.
(60) Provisional application No. 63/234,381, filed on Aug. 18, 2021.
(60) Provisional application No. 63/067,948, filed on Aug. 20, 2020.
(60) Provisional application No. 62/464,167, filed on Feb. 27, 2017.

(51) Int. Cl. H01M 10/0525; H01M 4/02; H01M 4/04; H01M 4/131; H01M 4/133; H01M 4/134; H01M 4/136; H01M 4/139; H01M 4/1393; H01M 4/505; H01M 4/62

(52) U.S. Cl. CPC H01M 10/0525; H01M 4/0416; H01M 4/131; H01M 4/133; H01M 4/134; H01M 4/136; H01M 4/139; H01M 4/1393; H01M 4/505; H01M 4/625; H01M 2004/027; H01M 2004/028

(57) ABSTRACT

A composite for improving electrochemical stability of an electrochemical device, comprises graphene; and an electrode active material having microscale particles. Said microscale particles are conformally coated by said graphene.

### CROSS-REFERENCE TO RELATED PATENT APPLICATIONS

This application claims priority to and the benefit of U.S. Provisional Application No. 63/234,381, filed Aug. 18, 2021, which is incorporated herein in its entirety by reference.

This application is a continuation-in-part application of U.S. application Ser. No. 17/369,058, filed Jul. 7, 2021, which is a divisional application of U.S. application Ser. No. 15/906,776, filed Feb. 27, 2018, now U.S. Pat. No. 11,088,392, which itself claims priority to and the benefit of U.S. Provisional Application No. 62/464, 167, filed Feb. 27, 2017, which are incorporated herein in their entireties by reference.

This application is also a continuation-in-part application of PCT Application No. PCT/US2021/044873, filed Aug. 6, 2021, which itself claims priority to and the benefit of U.S. Provisional Application No. 63/067,948, filed Aug. 20, 2020, which are incorporated herein in their entireties by reference.

### STATEMENT AS TO RIGHTS UNDER FEDERALLY-SPONSORED RESEARCH

This invention was made with government support under DE-AC02-06CH11357 awarded by the Department of Energy, and 1727846, 2039268, 2037026 and 1720139 awarded by the National Science Foundation. The government has certain rights in the invention.

### FIELD OF THE INVENTION

The present invention relates generally to the material science, and more particularly to composite materials with conformal graphene coating, fabricating methods and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Li-ion batteries (LIBs) have emerged as the dominant rechargeable energy storage technology for portable electronics, electric vehicles, and related mobile technologies. Since LIBs were first commercialized with LiCoO₂ (LCO) and graphite, cell-level energy densities have now nearly quadrupled through the incorporation of higher capacity active materials and optimized battery packaging. Nevertheless, demand still exists for even higher energy density LIBs, particularly for electric vehicle applications. For example, the cell-level energy densities of LIBs must approach 350 Wh kg⁻¹ and 750 Wh l⁻¹ for electric vehicles to reach parity with the mileage range of internal combustion vehicles, which implies energy densities of at least 800 Wh kg⁻¹ and 2600 Wh 1⁻¹ from the cathode active materials. Furthermore, because cathode active materials also play a decisive role in the overall voltage and cost of LIBs, considerable effort has been devoted to developing stable and reliable cathode materials with high specific and volumetric energy densities.

The family of layered oxides is the leading LIB cathode material technology due to its stable solid-state intercalation reactions and relatively fast two-dimensional Li-ion diffusion pathways. Specifically, layered oxides of the form LiMO₂ (M=transition metals such as Mn, Co, and Ni) can deliver theoretical capacities approaching 270 mAh g⁻¹ upon the extraction of one mole of Li. However, the electrochemically reversible capacity typically falls well short of this theoretical limit and is highly dependent on the transition metal component. For instance, the reversible capacity of LCO is only about 160 mAh g⁻¹ between 3.0 V and 4.3 V (all voltages will be expressed with respect to Li⁺/Li.). If Ni becomes the majority transition metal component, such as the LiNi_{0.8}Co_{0.1}Mn_{0.1}O₂ (NCM811) and LiNi_{0.8}Co_{0.15}Al_{0.05}O₂ (NCA) compositions, then layered oxides can deliver a capacity close to 200 mAh g⁻¹ within the same potential range. In addition, increasing the operating voltage window to over 4.3 V can extract more Li ions to approach the theoretical capacity limit, but these high-voltage conditions generally lead to severe irreversible degradation.

The single-component Ni-based layered oxide LiNiO₂ (LNO) is one of the most promising LIB cathode materials because it possesses a capacity (about 240 mAh g⁻¹) close to the theoretical limit, which satisfies the performance criteria for electric vehicles in terms of both specific (about 800 Wh kg⁻¹) and volumetric (about 2600 Wh l⁻¹) energy densities. Moreover, since the Co-free nature of LNO simultaneously addresses the cost and human-rights issues associated with the Co supply chain, LNO is regarded as a genuinely sustainable cathode for next-generation LIBs. However, despite its many merits, multiple drawbacks have impeded commercialization of LNO. For example, the production of high-quality LNO requires high precision in its synthetic conditions. Even slight deviations from the synthetic temperature or Ni/Li precursor ratio are highly detrimental to the electrochemical properties of LNO as it deviates from the stoichiometric phase. While this synthetic problem has been largely resolved with optimized synthetic conditions, a remaining issue for LNO is its poor cyclic stability, especially at the high operating voltages that are required to access its high capacity. In particular, the cycle life of LNO after 100 cycles at 0.5 C is less than 75% of the initial capacity of 230 mAh g⁻¹ when cycled up to 4.3 V. Although cycling to 4.1 V can improve the cyclic retention to 95%, these low-voltage conditions limit the initial capacity to 180 mAh g⁻¹.

Poor electrochemical stability is commonly observed in layered Ni-rich oxide cathodes when cycled over 4.3 V. The origin of this high-voltage degradation is not caused by a single mechanism, but by a complex entanglement of mechanical and chemical factors. Multi-phase transitions, large lattice parameter changes, electrochemical creep, and internal fatigue from surface reconstruction can all lead to mechanical cracking and loss of electrical contact to the current collector, ultimately causing capacity fade. These degradation phenomena also compromise secondary particle morphologies that have been widely employed to achieve high tap densities and power densities. In addition, chemical degradation, such as transition metal dissolution, singlet oxygen evolution, and Ni-ion migration, reduce the surface electrochemical activity, and can occur continuously during cycling due to the mechanical damage that generates new surfaces that act as further sites for degradation. In order to increase the stability of Ni-rich layered oxides, mitigation strategies such as secondary particle morphology control or doping to mitigate internal strain and stabilize particle surfaces have been attempted. Despite these previous efforts, reliably cycling LNO to voltages above 4.3 V, or more broadly, Ni-rich oxides above 4.6 V, remains a challenge largely due to destructive oxygen stacking transitions. Specifically, at low lithium content, LNO or Ni-rich layered oxides undergo an oxygen stacking transition from a face centered cubic (O3) structure to a hexagonal close packed structure (O1) that results in a rapid loss of electrochemical activity.

Therefore, a heretofore unaddressed need exists in the art to address the aforementioned deficiencies and inadequacies.

### SUMMARY OF THE INVENTION

In view of the aforementioned deficiencies and inadequacies, one of the objectives of this invention is to address issues of high-voltage degradation cascades associated with oxygen gas evolution and oxygen stacking chemistry with a conformal graphene coating on microscale LNO particles. Lattice oxygen loss is found to play a critical role in the local O3-O1 stacking transition at high states of charge, which subsequently leads to nickel-ion migration and irreversible stacking faults during cycling. This undesirable atomic-scale structural evolution accelerates microscale electrochemical creep, cracking, and even bending of layers, ultimately resulting in macroscopic mechanical degradation of LNO particles. By employing a graphene-based hermetic surface coating, oxygen loss is attenuated in LNO at high states of charge, which suppresses the initiation of the degradation cascade and thus substantially improves the high-voltage capacity retention of LNO.

In one aspect, this invention relates to a composite for improving electrochemical stability of an electrochemical device. Said composite comprises graphene; and an electrode active material having microscale particles, wherein said microscale particles are conformally coated by said graphene.

In one embodiment, said microscale particles have an average size of about 1 μm or larger than 1 μm.

In one embodiment, each of said microscale particles is uniformly and conformally coated with said graphene.

In one embodiment, each of said microscale particles is coated with amorphous carbon with sp²-carbon content along with said graphene.

In one embodiment, a ratio of said graphene to said cathode active material is in a range from about 0.05-10 wt %.

In one embodiment, said graphene comprises solution-exfoliated graphene. In one embodiment, said composite further comprises amorphous carbon with sp²-carbon content.

In one embodiment, the amorphous carbon is an annealation product of cellulose polymers.

In one embodiment, said composite is formed by annealing a mixture of said electrode active material, said graphene, and ethyl cellulose at a temperature for a period of time to decompose the ethyl cellulose, thereby resulting in said composite having said annealation product of the ethyl cellulose.

In one embodiment, said anode active material comprises Si, SiOₓ, Co₃O₄, MnO₂, and/or other conversion type anode materials.

In one embodiment, said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O2 (x>0.6).

In another aspect, the invention relates to an electrode for an electrochemical device. Said electrode comprises a composite comprising graphene, and an electrode active material having microscale particles, wherein said microscale particles are conformally coated by said graphene.

In one embodiment, each of said microscale particles is uniformly and conformally coated with said graphene.

In one embodiment, each of said microscale particles is coated with amorphous carbon with sp²-carbon content along with said graphene.

In one embodiment, a ratio of said graphene to said cathode active material is in a range from about 0.05-10 wt % in said composite.

In one embodiment, said graphene comprises solution-exfoliated graphene.

In one embodiment, said composite further comprises amorphous carbon with sp²-carbon content.

In one embodiment, the amorphous carbon is an annealation product of cellulose polymers.

In one embodiment, said composite is formed by annealing a mixture of said electrode active material, said graphene, and ethyl cellulose at a temperature for a period of time to decompose the ethyl cellulose, thereby resulting in said composite having said annealation product of the ethyl cellulose.

In one embodiment, said electrode active material comprises a cathode active material or an anode active material.

In one embodiment, said anode active material comprises Si, SiOₓ, Co₃O₄, MnO₂, and/or other conversion type anode materials.

In one embodiment, said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O₂ (x>0.6).

In one embodiment, said electrode has an abnormal overpotential exceeding 4.1 V, corresponding to an H2-H3 phase transition region.

In one embodiment, said graphene coating significantly suppresses oxygen gas evolution at high potentials over 4.1 V.

In one embodiment, said electrode has narrower (h0l) peak broadening.

In one embodiment, said electrode has intensities of (101) and (104) peaks that are relatively low, suggesting that the stacking structural evolution is mitigated by suppressed oxygen gas evolution.

In one embodiment, after ten cycles, said electrode still maintains its high-quality crystal structure with well-defined XRD peaks.

In one embodiment, the XRD patterns of the H3 phase (4.6 V) exhibits reduced O1 stacking transition or O1 stacking faults for said electrode.

In one embodiment, said electrode maintains 95% capacity retention after 50 cycles at C/10 at 4.3 V.

In one embodiment, said electrode has a 77% capacity retention even at 4.6 V cutoff.

In one embodiment, the secondary particle morphology of said composite remains intact after 50 cycles at 4.3 V.

In one embodiment, said microscale particles have an average size of about 1 μm or larger than 1 μm.

In one embodiment, said microscale particles are larger LNO particles (LG-LNO) having the average size of about 15 μm or larger than 15 μm.

In one embodiment, said LG-LNO electrode has a substantial improvement in capacity retention up to 85% after 100 cycles at 4.3 V.

In one embodiment, after 100 cycles with a 4.6 V cutoff voltage, said LG-LNO electrode continues to deliver an improved capacity retention of 76%.

In one embodiment, said LG-LNO electrode show a substantial improvement in cycling stability, which is attributed to the high-voltage degradation cascade being arrested by the conformal graphene coating suppressing oxygen evolution.

In yet another aspect, the invention relates to an electrochemical device comprising the above disclosed electrode.

In one embodiment, the electrochemical device is a battery.

In yet another aspect, the invention relates to a method for forming a composite. The method comprises providing an electrode active material having microscale particles; and coating said microscale particles conformally with a hermetic layer of graphene.

In one embodiment, said graphene comprises solution-exfoliated graphene.

In one embodiment, said coating comprises forming a mixture of said electrode active material graphene, and ethyl cellulose in a solvent to disperse said electrode active material and said graphene with the ethyl cellulose; and annealing the agitated mixture at a temperature for a period of time to decompose the ethyl cellulose, thereby resulting in said composite.

In one embodiment, each of said microscale particles is coated with amorphous carbon with sp²-carbon content along with said graphene.

In one embodiment, said coating is performed by a Pickering emulsion method.

In one embodiment, said microscale particles have an average size of about 1 μm or larger than 1 μm.

In one embodiment, a ratio of said graphene to said cathode active material is in a range from about 0.05-10 wt %.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows stacking structural evolution of LiNiO₂ according to embodiments of the invention. Panel a: Typical galvanostatic profile of LiNiO₂ and phase transition behavior. Panel b: Atomic models for O3 (left) and O1 (right) stacking. Panel c: X-ray diffraction patterns of pristine LNO electrodes and LNO electrodes after one cycle to 4.1, 4.3, and 4.6 V. Panel d: A stability map of O1 and O3 stackings according to Li content and oxygen vacancy concentration in their crystal lattice. Panel e: TEM images of LNO charged to 4.6 V. Panel f: Activation barrier of Ni ion migration in O1 stacking configurations. Black: without oxygen vacancy; orange: with oxygen vacancy. Observation of Ni ion arrangements in (panel g) O3 and (panel h) O1 stacking configurations was made possible by RABF; right-inset figures show the simulation results of O1 and O3 stackings with Ni defects.

FIG. 2 shows structural degradation of LNO cycled to high voltage according to embodiments of the invention. Panel a: SEM images of LNO after 50 cycles with a 4.3 V cutoff voltage at a C/10 charge rate. In the magnified images, cracking and creep are observed in primary particles. Panel b: Cross-sectional TEM image of LNO charged to 4.6 V. Bending (red arrows) and cracks (white arrows) along the (003) plane are observed. Panel c: High-resolution TEM and its local RABF images for the bending area. Panel d: Scheme for interparticle crack formation caused by primary particle deformation. Panel e: Atomic-scale scheme of the stacking transition and formation of stacking faults.

FIG. 3 shows electrochemical characteristics of LNO with suppressed oxygen evolution according to embodiments of the invention. Panel a: Galvanostatic charge/discharge profiles of bare LNO (black) and graphene-coated G-LNO (red) with SEM image (inset). Panel b: Differential capacity versus voltage curves for bare LNO (black) and G-LNO (red). Panel c: In situ DEMS results of (left) bare LNO and (right) G-LNO. Red and black lines indicate the relative pressure of CO₂ and O₂ gases, respectively. Panel d: High-resolution powder XRD results of 1 cycle (top) and 10 cycles (bottom) for bare LNO (black) and G-LNO (red) electrodes. Panel e: Discharge capacity versus cycle number for LNO and G-LNO at 4.3 and 4.6 V cutoff at C/10. After lithiation, the cells were held at 2.8 V until C/50 to minimize kinetic effects. Panel f: Discharge capacity retention versus cycle number. Panel g: SEM images after cycling of (top) LNO particle and (bottom) inside primary particles. In these images, the graphene coating was removed, and the area underneath was observed.

FIG. 4 shows long-term cycling characteristic of surface-stabilized LNO according to embodiments of the invention. Discharge capacity versus cycle number for LNO (black) and LG-LNO (red) at a rate of 1C with (panel a). 4.3 and (panel b) 4.6 V cutoff voltages. Panel c: Full-cell cycling test at a rate of 1 C for a 2.8-4.5 V voltage window.

FIG. 5 shows overcoming the traditional tradeoff between Ni content and cycle retention according to embodiments of the invention. A map of the relationship between Ni content and cycle retention for Ni-rich layered oxide cathodes. NCMxyz indicates LiNi_{0.x}Co_{0.y}Mn_{0.z}O₂ except for NCM111 (NCM111=LiNi_{0.33}Co_{0.33}Mn_{0.33}O₂). This graph represents the capacity retention after 100 cycles with 4.3 V. The black data points are taken from the literature.

FIG. 6 shows scanning electron microscope (SEM) images of as-synthesized LiNiO₂ (LNO) according to embodiments of the invention. Panel a: Lower-magnification SEM image. Panel b: higher-magnification SEM image.

FIG. 7 shows the Rietveld refinement result for the high-resolution X-ray diffraction (XRD) pattern of LiNiO₂ (wavelength=0.620838 Å) in panel a, and atomic position, occupancy, Uiso, and lattice parameters obtained from the refinement in panel b.

FIG. 8 shows an X-ray diffraction (XRD) pattern of a LiNiO₂ electrode charged to 4.6 V. The observed intensity ratio between (101) and (104) peaks matches well with a typical XRD pattern with 5% O1 stacking faults.

FIG. 9 shows details of XRD patterns of discharged (2.8 V, voltage hold until C/50) LNO electrodes after 1 cycle to 4.1, 4.3, and 4.6 V for panel a: (003), panel b: (101), panel c: (104), panel d: (105), and panel e: (107) peaks, according to embodiments of the invention. The broadening of (00l) and (10l) related peaks is observed. The (101) and (104) peak intensities are increased by 12 and 14%, respectively, after the 4.6 V cycle.

FIG. 10 shows XRD pattern simulations for LiNiO₂ with pure O3 (black), 5% Ni_{Li} defect (orange), 1% O1 stacking faults (blue), and combined 1% O1 stacking faults and 5% Ni_{Li} defect (red) for panel a: (003), panel b: (101), panel c: (104), panel d: (105), and panel e: (107) peaks, according to embodiments of the invention. In this simulation, the broadening of (00l) or (10l) related peak is observed with 1% O1 stacking faults. In the case of the combined 1% O1 stacking faults and 5% Ni_{Li} defect, (101) and (104) peak intensities are increased by 12 and 13%, respectively.

FIG. 11 shows oxygen vacancy defect formation energy in O3-type and O1-type LiₓNiO₂ based on first principles calculations. The calculation is performed under the dilute limit, and the oxygen chemical potential is referenced to ambient conditions.

FIG. 12 shows annular dark-field scanning transmission electron microscope (ADF STEM) images of the LiNiO₂ surface after charging to 4.6 V. The FFT analysis of these two regions confirms that most of surface region has transitioned into the rocksalt phase after charging to 4.6 V.

FIG. 13 shows nickel ion migration trajectory when a neighboring oxygen vacancy is present.

FIG. 14 shows simulation results of NiOₓ possessing O3 stacking from a [110] zone showing panel a: Supercell, panel b: HAADF (high-angle annular dark-field), panel c: ABF (annular bright-field), and panel d: RABF (reverse annular bright-field) with different Ni occupancies (0%, 50%, 75%, 100%) at Li sites. Panel e: Simulation setup condition using multi-slice image simulation from Dr. Probe software. Note that RABF is generated from the reversal contrast of ABF. Different occupancies of the Ni atomic columns at Li sites (indicated as red arrows) exhibit different contrast. HAADF and RABF at 100% Ni occupancy display homogeneous contrast over the Ni columns. The contrast in the RABF images between the 50% and 75%-filled Ni sites against the 100%-filled Ni sites are much lower and dimmer than those of HAADF.

FIG. 15 shows simulation results of NiOₓ of O1 stacking on zone showing panel a: Supercell, panel b: HAADF (high-angle annular dark-field), panel c: ABF (annular bright-field), and panel d: RABF (reverse annular bright-field) with different Ni occupancy (0%, 50%, 75%, 100%) at Li sites. Panel e: Simulation setup condition using multi-slice image simulation of Dr. Probe software.

FIG. 16 shows SEM images at different magnifications of LNO after 50 cycles with a 4.6 V cutoff voltage at C/10.

FIG. 17 shows oxygen stacking structure of panel a: O3 and rock salt phases and panel b: O1 phase.

FIG. 18 shows RABF images for bending area of cycled LiNiO₂. The dislocations due to the oxygen framework change are easily observed at the surface region.

FIG. 19 shows panel a: HAADF of charged LiNiO₂. panel b: Results of an inverse fast Fourier transform (IFFT) that filters planes showing vertical atomic displacement. panel c: IFFT that filters the (100) plane displaying horizontal atomic displacement. panel d: Overlay of HAADF (green) and IFFT (red) revealing the detailed defects. Note that the combined analysis of the HAADF and IFFT indicates high density of both vertical and horizontal atomic displacements, which are related to dislocation (half planes) and in-plane transitional glide phenomena. These defects are involved in the transformation between O3 and O1 structures during charge and discharge cycles.

FIG. 20 shows SEM images of graphene-coated LNO.

FIG. 21 shows thermogravimetric analysis of 4.1 V charged LNO and G-LNO electrodes. The graphene-coated LNO electrode was observed to have significantly reduced oxygen evolution at about 220° C.

FIG. 22 shows details of high-resolution XRD patterns after 1 cycle for LNO (black) and G-LNO (red) electrodes for panel a: (003), panel b: (101), panel c: (104), panel d: (105), and panel e: (107) peaks.

FIG. 23 shows details of high-resolution XRD patterns after 10 cycles for the LNO (black) and G-LNO (red) electrodes for panel a: (003), panel b: (101), panel c: (104), panel d: (105), and panel e: peaks.

FIG. 24 shows details of XRD patterns of LNO (black) and G-LNO (red) electrodes after charging to 4.1 V for panel a: (003), panel b: (101), panel c: (104), panel d: (105), and panel e: peaks.

FIG. 25 shows details of XRD patterns of LNO (black) and G-LNO (red) electrodes after charging to 4.6 V for panel a: (003), panel b: (101), panel c: (104), panel d: (105), and panel e: peaks. Here, both electrodes were charged to 90% SoC (near 4.6 V) and rested for 1 hour to minimize kinetic issues. As the theoretical calculation suggested, XRD patterns of G-LNO show reduced stacking faults signal for the H3 phase. The peak broadening of (003) peak and (101) peak intensities in the G-LNO electrode are significantly reduced.

FIG. 26 shows SEM images of G-LNO electrode after 50 cycles at C/10 to 4.3 V in panels a-c, and the interior of the particle (below the graphene coating) after cycling in panel d. The graphene exterior was carefully removed by a razor.

FIG. 27 shows SEM images of G-LNO electrode after 50 cycles at C/10 with 4.6 V in panels a-c, and the interior of the particle (below the graphene coating) after cycling in panel d.

FIG. 28 shows SEM images of (panels a-b) larger particle size LNO and (panels c-d) after graphene coating.

FIG. 29 shows discharge capacity versus cycle number for G-LNO (small particle size, red) and LG-LNO (large particle size, red) under a current density of 1C with 4.3 V cutoff voltage.

FIG. 30 shows SEM images of LG-LNO electrode after 100 cycles at 1C with 4.3 V in panels a-b. and 4.6 V cutoff voltages in panels c-d.

FIG. 31 shows cyclic retention was tested in a graphite full-cell configuration between 2.8 and 4.2 V with a current density of 0.5 C. The capacity retention of LG-LNO was near 85.8%, while the control electrode shows 76.1% capacity retention after 100 cycles. After another 100 cycles, LG-LNO and control electrodes showed 76.6% and 65.5% capacity retention, respectively.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this specification will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Cobalt-free LiNiO₂ (LNO) is one of the leading candidates for next-generation lithium-ion battery cathode materials due to its high energy density, sustainability, and economic feasibility. However, its poor high voltage stability has impeded its adoption in practical lithium-ion batteries, especially because high voltages are necessary to access its predicted performance metrics in terms of both gravimetric (˜800 Wh/kg) and volumetric (˜2600 Wh/L) energy densities.

In this invention, we successfully mitigate high-voltage degradation cascades associated with oxygen gas evolution and oxygen stacking chemistry with a conformal graphene coating on microscale LNO particles. Lattice oxygen loss is found to play a critical role in the local O3-O1 stacking transition at high states of charge, which subsequently leads to nickel-ion migration and irreversible stacking faults during cycling. This undesirable atomic-scale structural evolution accelerates microscale electrochemical creep, cracking, and even bending of layers, ultimately resulting in macroscopic mechanical degradation of LNO particles. By employing a graphene-based hermetic surface coating, oxygen loss is attenuated in LNO at high states of charge, which suppresses the initiation of the degradation cascade and thus substantially improves the high-voltage capacity retention of LNO.

In one aspect, the invention relates to a composite for improving electrochemical stability of an electrochemical device. Said composite comprises graphene; and an electrode active material having microscale particles, wherein said microscale particles are conformally coated by said graphene.

In one embodiment, said microscale particles have an average size of about 1 μm or larger than 1 μm.

In one embodiment, each of said microscale particles is uniformly and conformally coated with said graphene.

In one embodiment, each of said microscale particles is coated with amorphous carbon with sp²-carbon content along with said graphene.

In one embodiment, a ratio of said graphene to said cathode active material is in a range from about 0.05-10 wt %.

In one embodiment, said graphene comprises solution-exfoliated graphene.

In one embodiment, said composite further comprises amorphous carbon with sp²-carbon content.

In one embodiment, the amorphous carbon is an annealation product of cellulose polymers.

In one embodiment, said composite is formed by annealing a mixture of said electrode active material, said graphene, and ethyl cellulose at a temperature for a period of time to decompose the ethyl cellulose, thereby resulting in said composite having said annealation product of the ethyl cellulose.

In one embodiment, said electrode active material comprises a cathode active material or an anode active material.

In one embodiment, said anode active material comprises Si, SiOₓ, Co₃O₄, MnO₂, and/or other conversion type anode materials.

In one embodiment, said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O2 (x>0.6).

In another aspect, the invention relates to an electrode for an electrochemical device. Said electrode comprises a composite comprising graphene, and an electrode active material having microscale particles, wherein said microscale particles are conformally coated by said graphene.

In one embodiment, each of said microscale particles is uniformly and conformally coated with said graphene.

In one embodiment, each of said microscale particles is coated with amorphous carbon with sp²-carbon content along with said graphene.

In one embodiment, a ratio of said graphene to said cathode active material is in a range from about 0.05-10 wt % in said composite.

In one embodiment, said graphene comprises solution-exfoliated graphene.

In one embodiment, said composite further comprises amorphous carbon with sp²-carbon content.

In one embodiment, the amorphous carbon is an annealation product of cellulose polymers.

In one embodiment, said composite is formed by annealing a mixture of said electrode active material, said graphene, and ethyl cellulose at a temperature for a period of time to decompose the ethyl cellulose, thereby resulting in said composite having said annealation product of the ethyl cellulose.

In one embodiment, said electrode active material comprises a cathode active material or an anode active material.

In one embodiment, said anode active material comprises Si, SiOₓ, Co₃O₄, MnO₂, and/or other conversion type anode materials.

In one embodiment, said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O2 (x>0.6).

In one embodiment, said electrode has an abnormal overpotential exceeding 4.1 V, corresponding to an H2-H3 phase transition region.

In one embodiment, said graphene coating significantly suppresses oxygen gas evolution at high potentials over 4.1 V.

In one embodiment, said electrode has narrower (h0l) peak broadening.

In one embodiment, said electrode has intensities of (101) and (104) peaks that are relatively low, suggesting that the stacking structural evolution is mitigated by suppressed oxygen gas evolution.

In one embodiment, after ten cycles, said electrode still maintains its high-quality crystal structure with well-defined XRD peaks.

In one embodiment, the XRD patterns of the H3 phase (4.6 V) exhibits reduced O1 stacking transition or O1 stacking faults for said electrode.

In one embodiment, said electrode maintains 95% capacity retention after 50 cycles at C/10 at 4.3 V.

In one embodiment, said electrode has a 77% capacity retention even at 4.6 V cutoff.

In one embodiment, the secondary particle morphology of said composite remains intact after 50 cycles at 4.3 V.

In one embodiment, said microscale particles have an average size of about 1 μm or larger than 1 μm.

In one embodiment, said microscale particles are larger LNO particles (LG-LNO) having the average size of about 15 μm or larger than 15 μm.

In one embodiment, said LG-LNO electrode has a substantial improvement in capacity retention up to 85% after 100 cycles at 4.3 V.

In one embodiment, after 100 cycles with a 4.6 V cutoff voltage, said LG-LNO electrode continues to deliver an improved capacity retention of 76%.

In one embodiment, said LG-LNO electrode show a substantial improvement in cycling stability, which is attributed to the high-voltage degradation cascade being arrested by the conformal graphene coating suppressing oxygen evolution.

In yet another aspect, the invention relates to an electrochemical device comprising the above disclosed electrode.

In one embodiment, the electrochemical device is a battery.

In yet another aspect, the invention relates to a method for forming a composite. The method comprises providing an electrode active material having microscale particles; and coating said microscale particles conformally with a hermetic layer of graphene.

In one embodiment, said graphene comprises solution-exfoliated graphene.

In one embodiment, said coating comprises forming a mixture of said electrode active material graphene, and ethyl cellulose in a solvent to disperse said electrode active material and said graphene with the ethyl cellulose; and annealing the agitated mixture at a temperature for a period of time to decompose the ethyl cellulose, thereby resulting in said composite.

In one embodiment, each of said microscale particles is coated with amorphous carbon with sp²-carbon content along with said graphene.

In one embodiment, said coating is performed by a Pickering emulsion method.

In one embodiment, said microscale particles have an average size of about 1 μm or larger than 1 μm.

In one embodiment, a ratio of said graphene to said cathode active material is in a range from about 0.05-10 wt %.

Among other things, the invention may have applications in lithium-ion batteries, nickel-rich layered oxide cathode materials, cobalt-free cathode, high energy density cathode, high voltage operation battery, or the likes.

The advantages of the invention include, but are not limited to, Hermetic graphene coating suppresses oxygen evolution from LiNiO_{2;} Graphene coating prevents detrimental O3-O1 stacking transition at high states of charge, mitigating intraparticle and interparticle mechanical degradation; Suppression of oxygen evolution further mitigates side reactions from oxygen radicals; and Graphene coating on LiNiO₂ improves cycle retention especially at high voltages above 4.3 V (vs. Li/Li⁺).

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Elucidating and Mitigating High-Voltage Degradation Cascades in Cobalt-Free LiNiO₂ Lithium-Ion Battery Cathodes

Cobalt-free LiNiO₂ (LNO) is a promising cathode material for next-generation Li-ion batteries due to its exceptionally high capacity and cobalt-free composition that enables more sustainable and ethical large-scale manufacturing. However, its poor cycle life at high operating voltages over 4.1 V impedes its practical use, thus motivating efforts to elucidate and mitigate LiNiO₂ degradation mechanisms at high states of charge (SoC).

In this exemplary study, a thorough exploration of the high-voltage degradation mechanism of LNO including its relationship to the evolution of oxygen stacking is presented. Due to the loss of lattice oxygen, local oxygen stacking changes from the face centered cubic (O3) structure to the hexagonal close packed structure (O1) occur prematurely in LNO compared to Ni-rich oxides. The subsequent formation of Ni_{Li} defects in the O1 structure then induces irreversible generation of stacking faults that accelerate mechanical degradation in primary particles due to crystal structure incoherency, which rapidly reduce the electrochemical activity of LNO. Since this degradation cascade is initiated by the loss of lattice oxygen, stable high-voltage operation should be achievable through the use of surface coatings that suppress oxygen evolution without compromising other aspects of rechargeable LIB operation. Towards this end, we employ a graphene-based hermetic surface coating that attenuates oxygen loss at high SoCs, thus suppressing the initiation of the degradation cascade and substantially improving the high-voltage capacity retention of LNO. Overall, this exemplary study provides detailed mechanistic insight into the high-voltage degradation of LNO, resulting in a mitigation strategy that can serve as the basis of next-generation high energy density LIBs.

### METHODS

### Material Synthesis

Ni(OH)₂ precursor powders were synthesized continuously using a Taylor Vortex Reactor (TVR) via the hydroxide co-precipitation method. LiOH·H₂O (Millipore Sigma) and precursor powder were combined using an acoustic mixer and calcined in a box furnace to obtain LiNiO₂ cathode powder. As-synthesized LiNiO₂ powder was coated with about 1 wt. % of a graphene nanocomposite using a Pickering emulsion method. The nanocomposite was synthesized via solution-phase shear mixing of graphite (+150 mesh, Millipore Sigma) and ethyl cellulose (4 cP, Millipore Sigma). Ethyl cellulose and shear-mixed graphene flake mixture was first sonicated with a mass ratio of 2:1 in acetonitrile solvent. Subsequently, LiNiO₂ powder and hexane in a 1:5 v/v ratio of acetonitrile were added to the dispersion. After fractional distillation, the dried composite was heated up to 240° C. for 10 min under an oxygen atmosphere to pyrolyze the residual ethyl cellulose. For a reliable comparison, the bare-LNO powder was also subjected to the same chemical and post-heat treatment procedure as G-LNO. More details on the coating method are described in previously published work.

### Sample Characterization

XRD measurements were conducted in a Scintag XDS 2000 X-ray diffractometer equipped with a Ge (Li) solid-state detector and a Cu Kα anode (λ=1.5418 Å). The equipment was operated using an accelerating voltage of 40 kV and a current of 20 mA. The synchrotron XRD experiments were carried out at the DND-CAT beamline 5BMC at the Advanced Photon Source at Argonne National Laboratory. The 4.6 V charged samples were sealed in capillaries, which continuously rotated about a horizontal axis to allow a 2×8 mm² X-ray beam to strike the sample along its length. The powder diffractometer was used in a high-resolution Bragg-Brentano geometry with a constant energy of 19.970 keV (λ=0.620821 Å). The incident beam optics setup includes a double bounce pseudo-channel-cut crystal configuration of two Si (111) crystals. An anti-scatter flight tube followed by Soller slits with a vertical blade for limiting horizontal axial divergence was outfitted on the detector. Additionally, a Ge (220) analyzer crystal was utilized before acquiring the signal with an Oxford Cyberstar scintillation counter. The electron microscope images were obtained by SEM (Hitachi SU8030) and TEM (JEOL ARM 200CF). The simulation setup condition was established using multi-slice image simulation of Dr. Probe software.

### Density Functional Theory Calculations

The density functional theory (DFT) calculations in this work were performed using the Vienna Ab initio Simulation Package (VASP) within the projector augmented-wave approach. The projector-augmented wave method was used in conjunction with the Perdew-Burke-Ernzerhof revised PBEsol version for the exchange-correlation functional. A GGA+U parameterization was used, and the (/values for Ni were set to 6.2 eV. Additionally, a cutoff energy of 520 eV for the plane-wave basis set was used, along with Γ-centered k-meshes with a density of 2500 k-points per reciprocal atom in all calculations. The Li ordering of ground-state structures LiₓNiO₂ (no oxygen vacancy or Ni migration) was based on previously reported results. The structures with oxygen vacancies were created by fixing the Li ordering and removing non-symmetric oxygen atoms. To enumerate possible orderings, enumlib was employed and no more than 20 configurations were selected with the lowest electrostatic energy possible as candidate structures. DFT calculations were then executed for these candidate structures, and the one with the lowest energy was selected as the representative ground-state structure. All calculations were spin-polarized with the spin states designated to be ferromagnetic. For the nudged elastic band (NEB) calculation of Ni migration, the Li ordering was first reordered based on the structure with an out-of-plane Ni atom migration. The same ordering method used for creating the structure with oxygen vacancies was applied. Finally, Li ordering was fixed and a path was created for Ni migration.

### Electrode Fabrication and Electrochemical Testing

Slurries with active powders, carbon black (MTI corporation, EQ-Lib-SuperP), and PVDF binder (corporation, EQ-Lib-PVDF) with N-methyl-2-pyrrolidone (NMP) were prepared for the electrode fabrication. The mixture was cast on aluminum foil with an active loading density about 5 mg cm⁻² and dried in a 120° C. convection oven. CR2032 coin cells were assembled with Li metal (MTI corporation, reference electrode), glass fiber (Whatman, separator), and 1.2 M LiPF₆ in ethylene carbonate/ethyl methyl carbonate of 3:7 volume ratio with 2 wt. % of vinylene carbonate (Millipore Sigma, EC/EMC, electrolyte). The full-cell test was conducted with an N/P ratio 1.18 with graphite anode electrode. Coin cells were cycled in an LBT-20084 Arbin battery cycler between 2.8-4.3 V or 2.8-4.6 V versus Li/Li⁺. The current density of 1C was defined as 200 mA g⁻¹.

### In Situ Differential Electrochemical Mass Spectrometry

To analyze gas evolution during cycling, differential electrochemical mass spectrometry (DEMS) was used. The in situ gas analysis system was configured by combining a mass spectrometer (Hiden Analytical HPR-20 R&D) with a potentio-galvanostat (WonA Tech, WBCS 3000). Each cell was assembled into a custom-built coin cell, wherein the cap possessed a small hole (1 mm diameter) in the center to expel gas evolved from the cathode. Each cell was rested for 3 h before the test, and electrochemical performance was measured at a constant rate of 0.1C with a cutoff voltage between 2.8 and 4.6 V. We used a 20 mg cm-1 electrode loading density to maximize gas detection. During the experiment, the mass flow controller (WIZ-701C-LF) flowed Ar carrier gas at a constant rate of 15 cc min⁻¹ such that the evolved gas during the electrochemical test was promptly swept into the mass spectrometer.

### RESULTS AND DISCUSSIONS

### Oxygen Stacking Transition and Stacking Faults

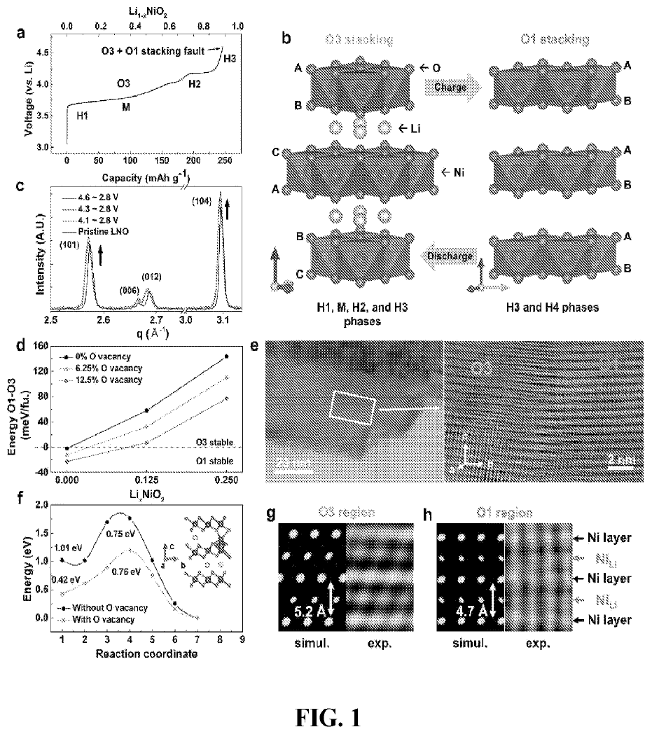

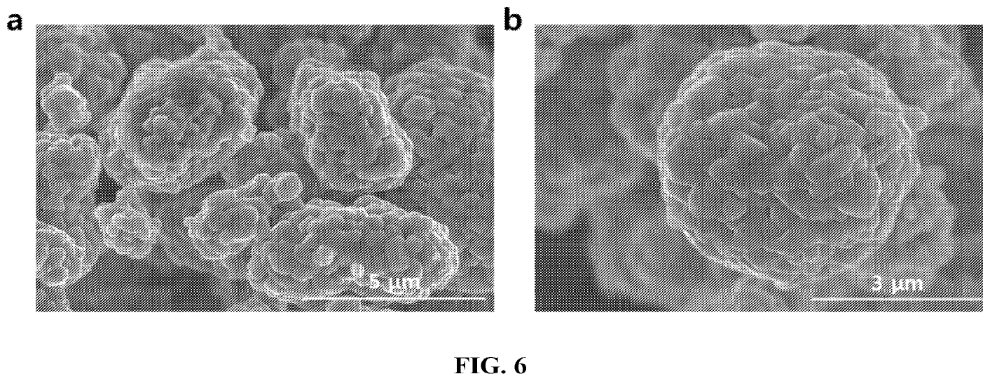

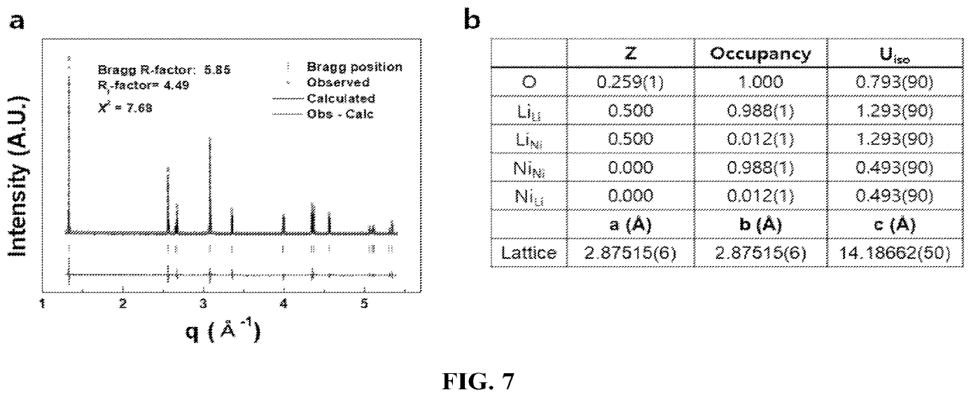

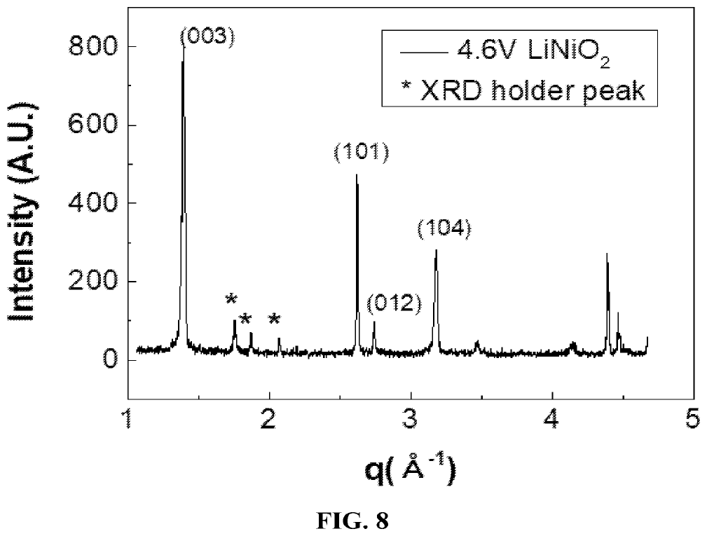

LNO powder was synthesized with a secondary particle morphology (FIG. 6) by the conventional solid-state method. Rietveld refinement (FIG. 7) confirmed the high-quality LNO crystal structure with about 1% Ni_{Li} defect concentration. Upon delithiation, LiₓNiO₂ (0≤x≤1) undergoes first-order phase transitions in the order H1, M, H2, and H3, as shown in panel a of FIG. 1, where H and M represent the hexagonal and monoclinic phases, respectively. As-synthesized LNO begins in the H1 phase, corresponding to an O3-type oxygen stacking with a repeated AB CA BC oxygen sequence (face centered cubic) as shown in panel b of FIG. 1, (left), where Li and Ni ions occupy octahedral sites coordinated with oxygen ligands. During charging above 4.1 V, O1-type stacking appears with an AB oxygen sequence (hexagonal close packed, as shown in panel b of FIG. 1, right), which is accompanied by an H3 phase transition. The formation of 5% O1 stacking faults were observed after charging to 4.6 V, as shown in FIG. 8, which is consistent with previous literature. Although it has been reported that sustained high voltage conditions for more than 20 hours results in additional H′3 (defective H3 with mainly O3 stacking) and H4 (mainly O1 stacking) phases, these phases are rarely observed in conventional galvanostatic charging and discharging.

In principle, the electrochemically induced O1 stacking can reversibly glide back to the original O3 stacking during relithiation. However, our X-ray diffraction (XRD) results show that the partial O1 stacking (i.e., O1 stacking faults) remain even after complete relithiation.

Specifically, panel c of FIG. 1 shows the XRD patterns of LNO electrodes after one cycle to 4.1, 4.3, and 4.6 V cutoff voltages. In these experiments, the voltage is held at 2.8 V until the current reaches C/50 to confirm that the presence of the stacking faults is not due to kinetic limitations associated with galvanostatic cycling. After subjecting the LNO electrodes to these cycling conditions, the intensities of the (101) and (104) peaks increase with increasing cutoff voltage.

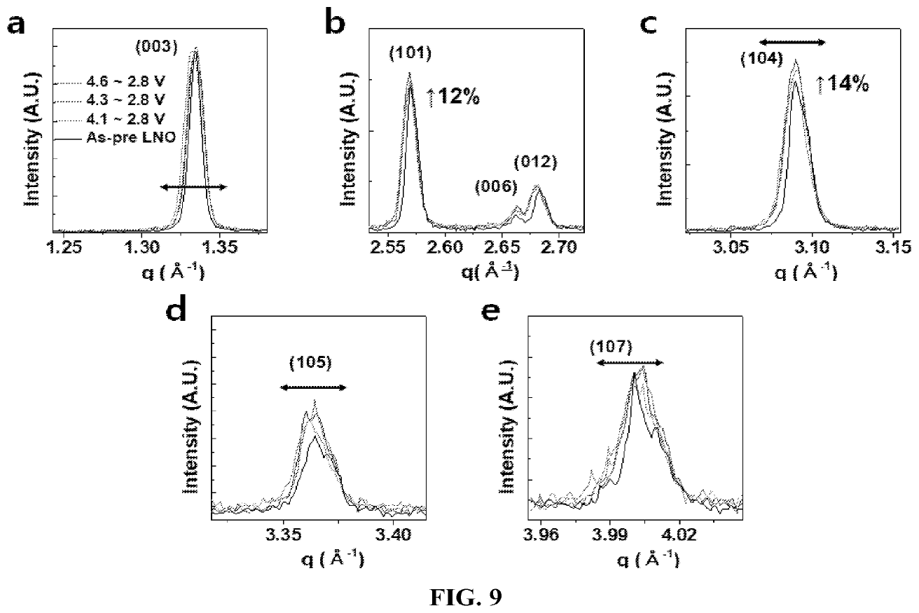

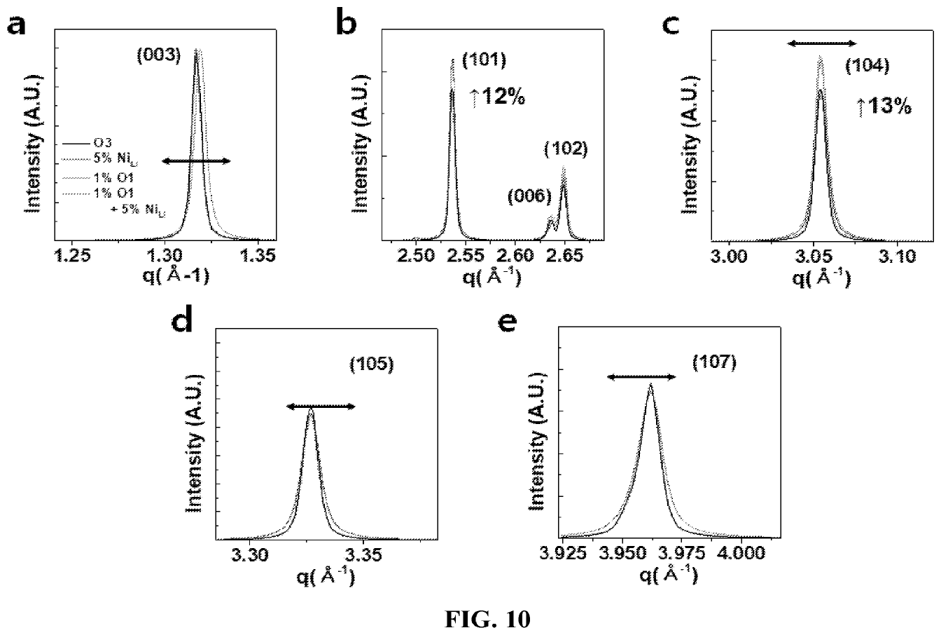

Moreover, compared to the XRD pattern of as-synthesized LNO, a noticeable peak broadening is observed for the (h0l) and (0kl) peaks for the cycled electrodes (more details of the XRD peaks are shown in FIG. 9). It is well known that the migration of Ni ions into Li sites results in the simultaneous weakening of the (101) peak intensity and strengthening of the (104) peak intensity. Thus, the observed (104) peak intensity increase can be attributed to the presence of Ni_{Li} defects. On the other hand, the increased (101) peak intensity and its abnormal peak broadening are typical diffraction changes caused by oxygen stacking faults along the c-direction. Diffraction pattern simulation by DIFFaX also supports this conclusion. DIFFaX simulation results for a structure with 5% Ni_{Li} defects and about 1% O1 stacking fault concentration show the best agreement with the experimental results after one galvanostatic cycle, as shown in FIG. 10.

### Origin of Stacking Structural Evolution

O1 stacking faults in LNO are generated at high SoCs, which is analogous to the behavior found in LCO. The O3-type structure is thermodynamically stable at low SoCs when compared to the O1-type structure since the O3 stacking configuration has a lower electrostatic energy between NiO₂ slabs. However, in the high SoC regime, the reduced c-lattice parameter leads to the overlap of oxygen p orbitals from neighboring NiO₂ slabs, which are highly covalent. To minimize the direct interaction between O p orbitals, the oxygen stacking structure transitions into O1-type stacking at high levels of delithiation. Despite this qualitative argument, first principles calculations (panel d of FIG. 1, black line) show that O3-type stacking is 143 meV/f.u. and 58 meV/f.u. more favorable than the O1-type structure at Li content x=0.25 and x=0.125, respectively. Only at a pure NiO₂ composition (Li content x=0) does the O1-type structure become 2 meV/f.u. more favorable than the O3-type structure. These calculations thus suggest that the O1-type structure should only appear at nearly full delithiated compositions of LNO (about 270 mAh g⁻¹ of charge capacity). However, the experimental observations consistently reveal that O1 stacking faults form much earlier near a Li_{˜0.1}NiO₂ composition (about 240 mAh g⁻¹, FIG. 8), which is concomitant with the H3 phase transition.

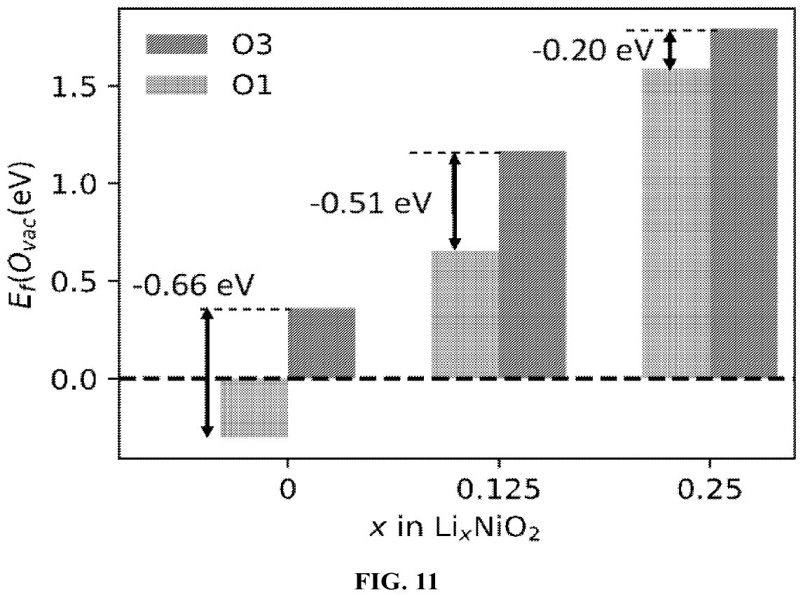

This apparent inconsistency between the theoretical and experimental phase diagrams can be resolved when considering the effect of lattice oxygen loss. Oxygen evolution during electrochemical cycling is a common issue in layered oxide cathode materials. In particular, Ni-rich layered oxides lose oxygen from the surface following charging to about 4.1 V, triggering electrochemical instability at high voltages. The relationship between oxygen evolution and high SoCs is investigated by calculating the oxygen defect formation energy of LiₓNiO₂ for O1-type and O3-type structures at different Li concentrations: x=0.25, 0.125, 0, as shown in FIG. 11. The oxygen vacancy formation energies for O3-LiₓNiO₂ E (O3-O_{vac}) at x=0.25, 0.125, and 0 are 1.79 eV, 1.16 eV, and 0.36 eV, respectively. In comparison, the oxygen vacancy formation energies for O1-LiₓNiO₂ F (O1-O_{vac}) at x=0.25, 0.125, and 0 are 1.59 eV, 0.65 eV, and −0.30 eV, respectively. Both O3-type and O1-type structures show lower oxygen vacancy defect formation energies as Li content decreases, suggesting that oxygen loss is favorable at high SoCs. Specifically, the oxygen defect formation energy in O1-NiO₂ is negative, which implies that oxygen vacancy formation in this structure is highly favorable and could go beyond the dilute limit. In contrast, the oxygen vacancy defect formation energy in O3-NiO₂ remains positive even when fully delithiated, suggesting that the O3-type structure can better retain oxygen in the lattice during charging. Therefore, maintaining O3-type stacking is critical to suppressing oxygen loss and improving the long-term cycling performance of LNO.

The interplay between oxygen vacancy formation and O3-O1 stacking changes leads to a deleterious positive feedback loop. The energy difference between O1-type and O3-type structures with 5% (orange) and 10% (green) oxygen vacancies, as shown in panel d of FIG. 1, is compared and it is found that the O1-type structure becomes stable earlier during charging when oxygen vacancies are present. In other words, oxygen vacancy formation drives an earlier transition from O3-type to O1-type stacking, while the formed O1-type stacking facilitates the formation of oxygen vacancies. This self-reinforcing synergistic effect explains why O1-type stacking, when formed under high voltage charging, is highly detrimental to the material structure as it leads to irreversible oxygen loss and ultimately capacity fade.

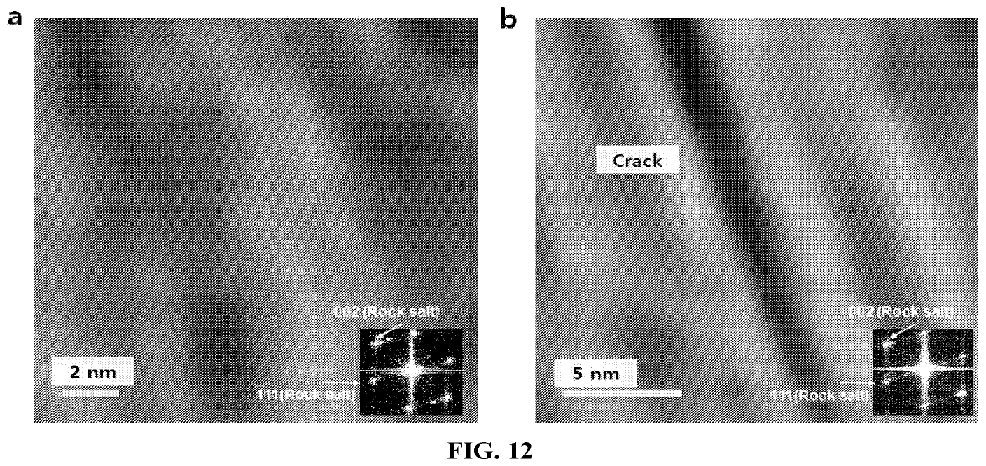

Oxygen vacancy formation and gas release mainly occurs at the liquid-solid (i.e., electrolyte-active material) interface rather than at solid-solid interfaces (e.g., grain boundaries). Consequently, the local oxygen vacancy concentration near the exterior surface of a secondary particle is likely to be higher than near the interior, which suggests that the O3-O1 stacking transition should be observed locally near the surface. Panel e of FIG. 1 shows scanning transmission electron microscopy (STEM) images of the LNO surface when charged to 4.6 V. Most of the LNO particle surface has already transformed into a NiO-like phase, as shown FIG. 12, but the near-surface region still maintains a layered structure, as shown in panel e of FIG. 1. A significant amount of O1 stacking in the surface region is observed although the overall percentage of O1 stacking is expected to be about 5%, corroborating the spatial favorability of O1 stacking transitions near the surface. Moreover, this result is in line with recent observations that the bulk structure of LNO cycled to 4.3 V has the O3 structure, whereas the surface of LNO possesses the O1 structure after 100 cycles.

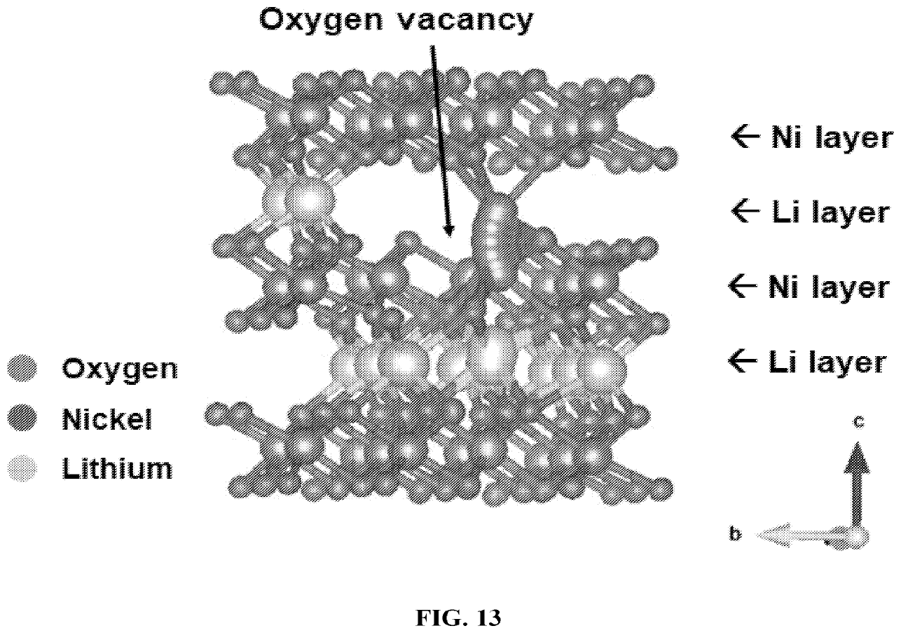

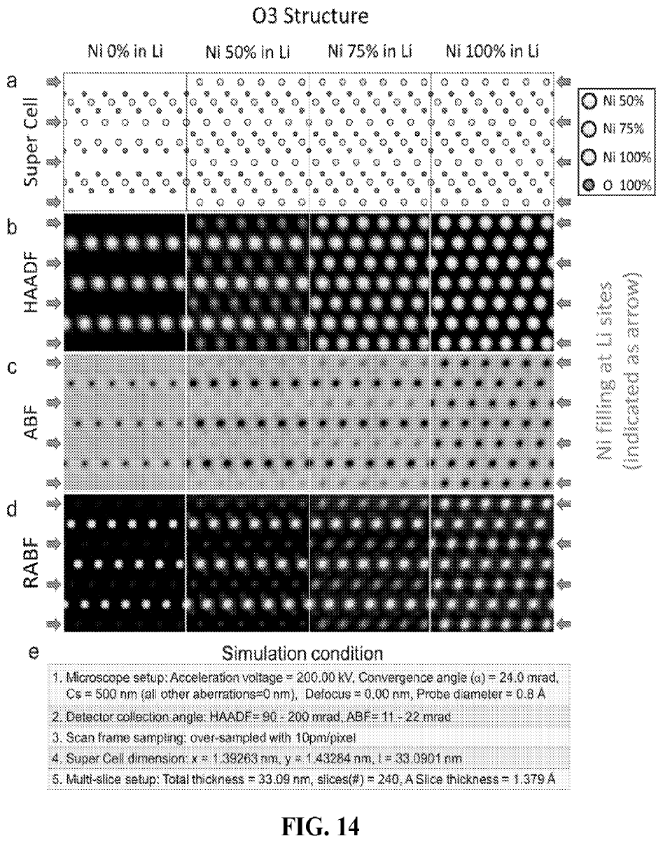

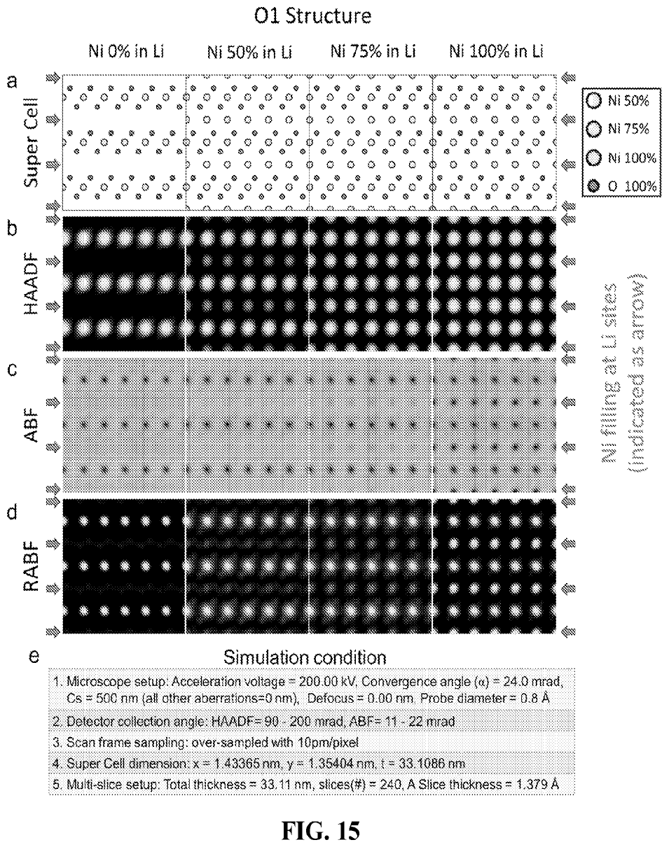

Besides leading to earlier O3-O1 stacking transitions, Ni migration easily occurs in O1-type stacking, forming Ni_{Li} antisite defects. First principles calculations show that the thermodynamic driving force for Ni ions to move into the Li layer is 1.01 and 0.42 eV with and without oxygen vacancies, respectively, with a migration barrier of about 0.75 eV, as shown in panel f of FIG. 1 and FIG. 13. Direct observation by reverse annular bright-field (RABF) STEM on LNO charged to 4.6 V confirms the Ni_{Li} defect formation, as shown in panel g of FIG. 1. In the O3 structure region, Ni ions are arranged diagonally with Ni_{Li} defects, which is a well-known transition metal atomic configuration for O3-type layered oxides (see the inset simulation result). On the other hand, Ni ions are arranged in a line exactly along the c-axis in the O1 stacking region, as shown in panel h of FIG. 1. Moreover, additional Ni ions between layers are observed. This configuration is in good agreement with the simulation results for Ni_{Li} defects in the O1-type structure (right inset of panels g-h of FIG. 1 with the simulation details provided in FIGS. 14 and 15). Additional Ni ions between the Ni_{Li} and NiO₂ layer are expected due to the severe distortion of the structure.

Impurities between slabs affect the stacking sliding dynamics. Specifically, the Ni_{Li} defect plays a role as a “pillar” between NiO₂ layers, impeding the oxygen stacking gliding between O1 and O3. For example, the H4 phase is expected to have a CdI2 structure with pure O1 stacking, but actual oxygen stacking contains a considerable amount of O3 stacking faults due to its site-exchanged Ni_{Li} defects in the original O3 structure. If the as-synthesized O3-type LNO has a Ni_{Li} concentration of more than 7%, the stacking transition into O1-type is completely blocked during charging by the maximized pillar effect. Likewise, Ni_{Li} defects in O1 stacking contribute to the formation of O1 stacking faults during cycling by reducing the stacking transition reversibility back to O3.

### High-Voltage Degradation of LiNiO₂

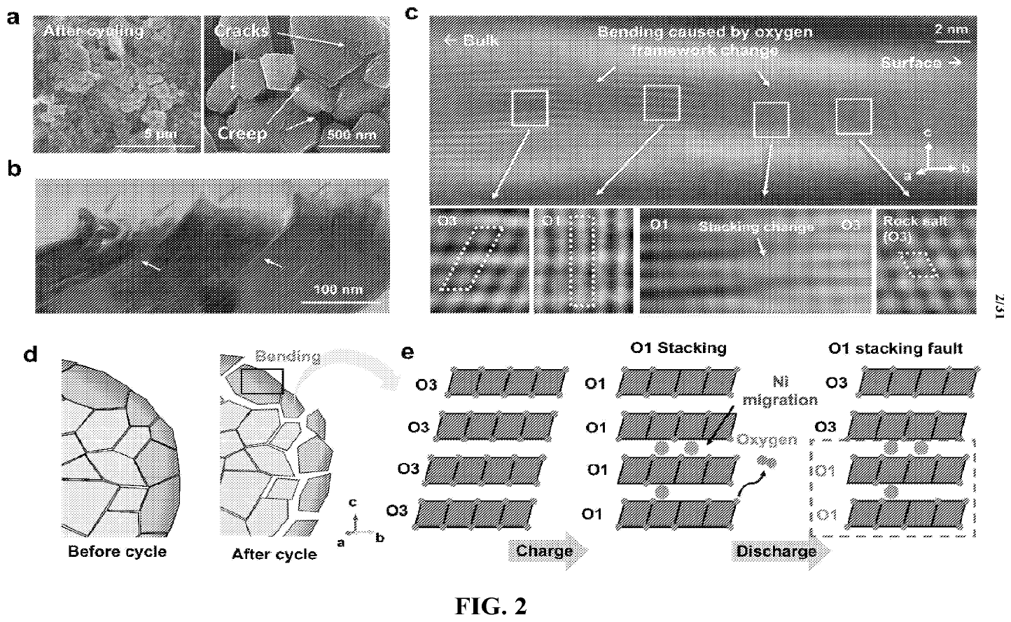

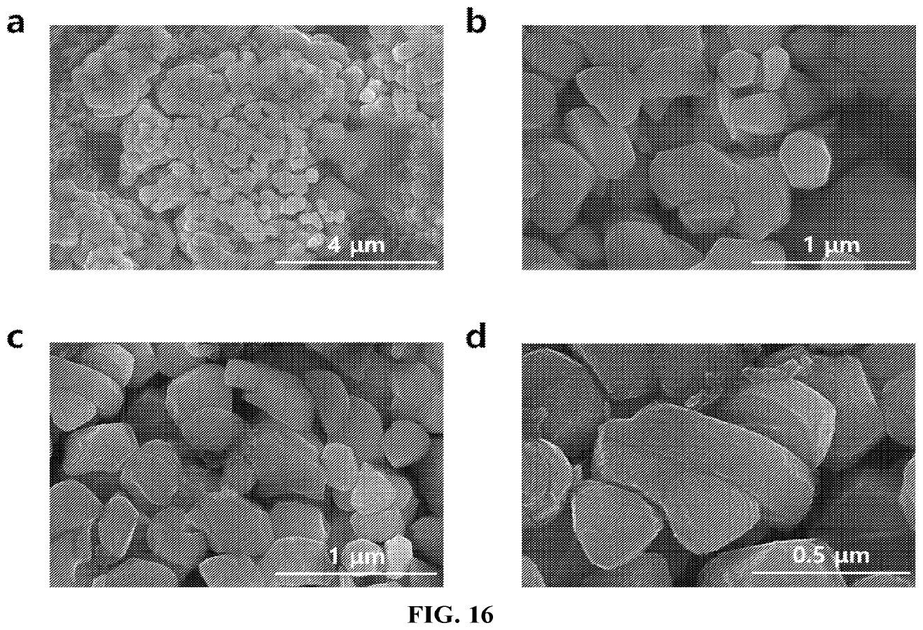

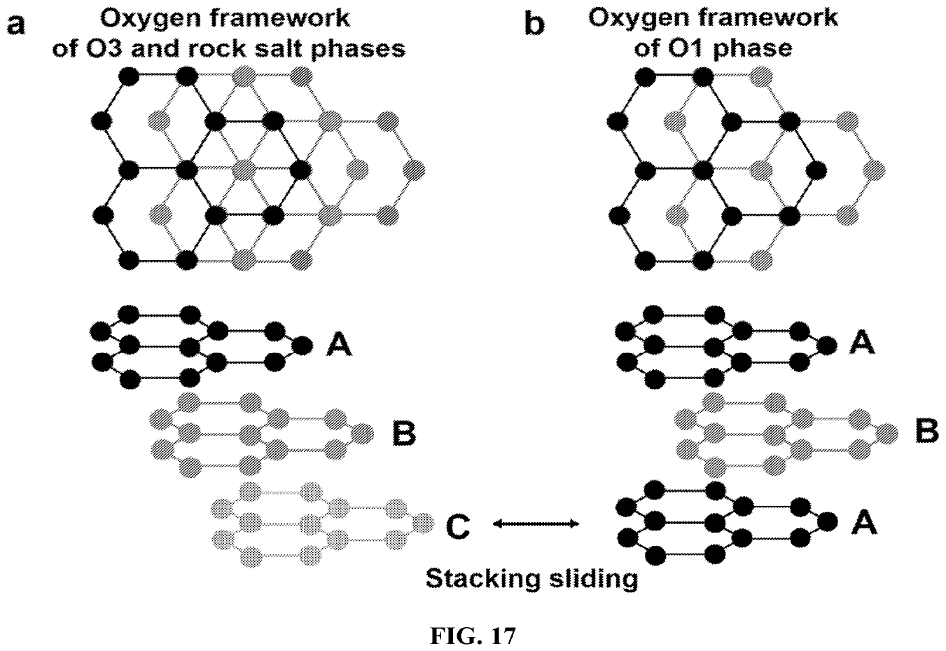

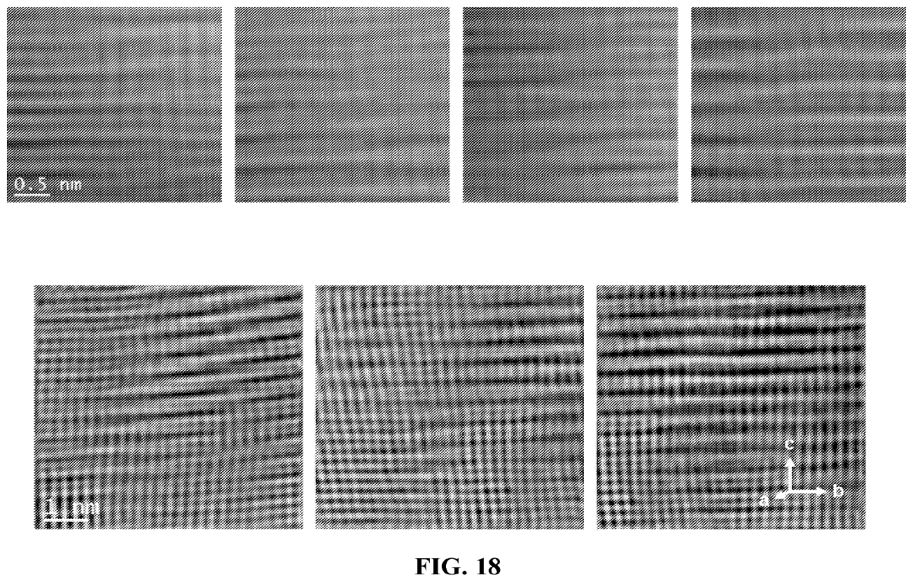

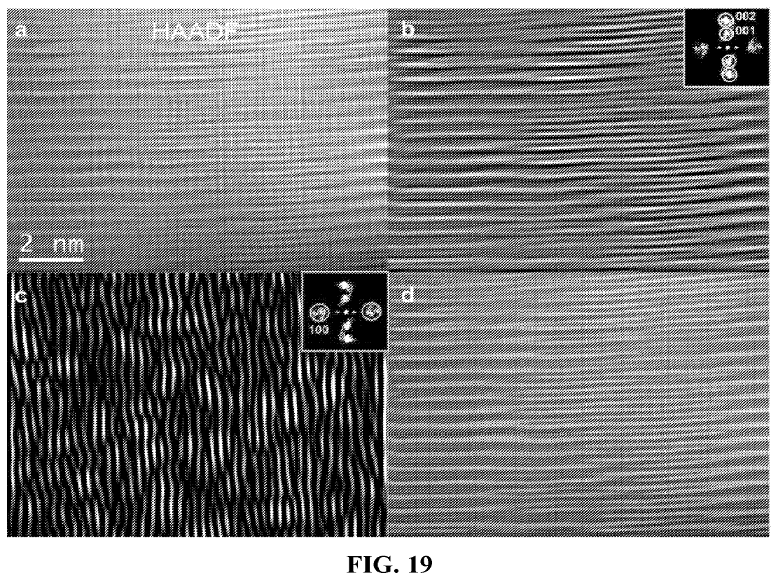

In general, the oxygen stacking transition is a detrimental structural evolution that can induce creep and cracking of active particles, as observed not only in many LIB layered cathode materials but also sodium-ion cathode materials. Especially for LNO, the substantial c-lattice parameter change accompanying the H2-H3 two-phase reaction accelerates the generation of local stacking faults and induces significant mechanical degradation. Panel a of FIG. 2 shows the typical intergranular cracks found in a secondary particle of LNO after 50 cycles up to 4.3 V at a C/10 rate with substantial primary particle creep observed by scanning electron microscopy (SEM). This primary particle creep becomes more significant following 4.6 V cycling, as shown in FIG. 16, which is in good agreement with recent literature. Cross-sectional TEM of the surface region shows that serious bending occurs at the edge of layers (see the red arrows in panel b of FIG. 2) and that the deformation is quite different from previously observed straight cracks along (003) planes (see the white arrows in panel b of FIG. 2). The atomic-scale view of the particle edge (panel c of FIG. 2) shows that this unexpected bending is attributed to the incoherency of the oxygen stacking structure. The O3 and rock salt phases share the same oxygen framework of AB CA BC stacking, but the O1 structure possess a different AB stacking sequence, as shown in FIG. 17. Once the O1 stacking faults are formed between O3 stacking (bulk) and rock-salt (surface) phases along the (003) plane as shown in the inset figures of panel c of FIG. 2, dislocations are inevitably formed (yellow-colored inset figure and FIGS. 18 and 19). Thus, severe layer bending occurs, especially at the surface region due to the high concentration of stacking transitions.

Based on these cumulative observations, a cascade for high-voltage degradation of LNO can be delineated. At the initial state, LNO has a pristine secondary particle morphology with O3-type stacking, as shown in panels d-e of FIG. 2. When the electrode is charged over 4.1 V, loss of lattice oxygen occurs at the secondary particle surface that is in direct contact with the electrolyte (red-colored regions in panel d of FIG. 2). As depicted in panel e of FIG. 2, the oxygen loss provides a thermodynamic driving force for the O3-O1 stacking change. The O1 stacking formation facilitates further oxygen vacancy formation and detrimental structural evolution. Following the O3-O1 stacking transition, Ni migration occurs in the local O1 stacking region. These Ni_{Li} antisite defects act as pillars between NiO₂ slabs, which prevent the slabs from gliding back during discharge, causing the stacking change to be irreversible. Thus, the O1 stacking faults are increasingly prevalent and result in incoherency of the oxygen framework. After repeated cycles, the accumulated stacking faults and oxygen evolution accelerate the primary particle deformation of bending, creep, and cracking, especially for the red region in panel d of FIG. 2. Eventually, the primary particle deformation leads to interparticle cracking within the secondary particles, resulting in compromised internal electrical connections after cycling as depicted in panel d of FIG. 2 (right).

### Mitigation of High-Voltage Degradation

In light of the high-voltage degradation cascade, the key to realizing high-voltage operation of LNO is to suppress the initial surface oxygen loss and thus the O1 stacking transition following charging. Moreover, the suppression of oxygen evolution should also alleviate associated issues such as chemomechanical degradation or electrolyte decomposition. To test this hypothesis, LNO powders are prepared possessing small secondary particle sizes (about 3 μm, as shown in FIG. 6) to maximize the surface area. These particles are then conformally coated with a hermetic layer to kinetically suppressing the release of oxygen. In particular, a graphene exterior coating is selected due to its large barrier to oxygen diffusion and its weak chemical interaction with the LNO surface in contrast to other possible coating layers such as Al₂O₃ that could alter the nature of the surface oxygen framework.

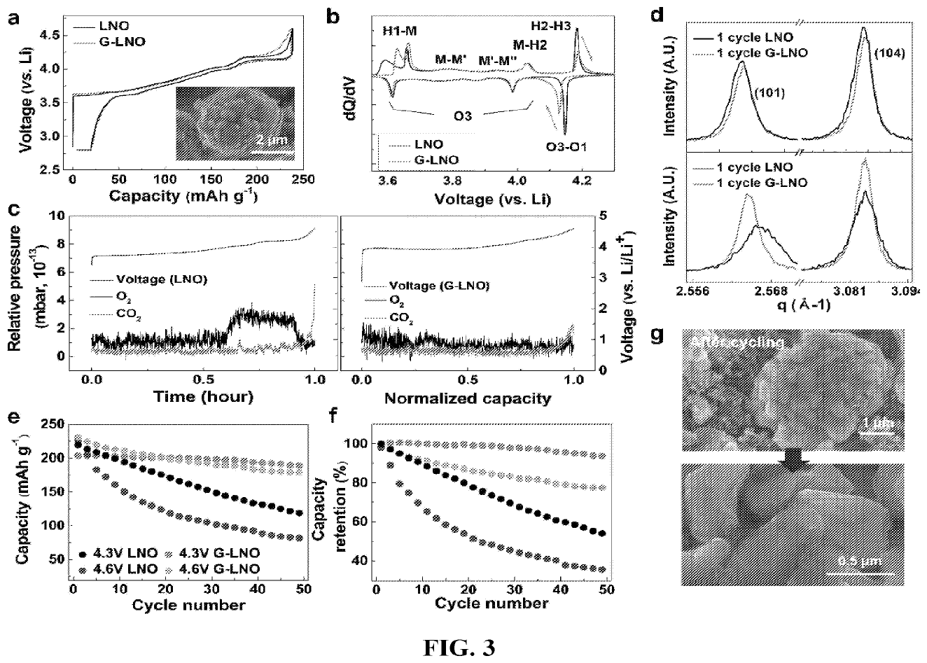

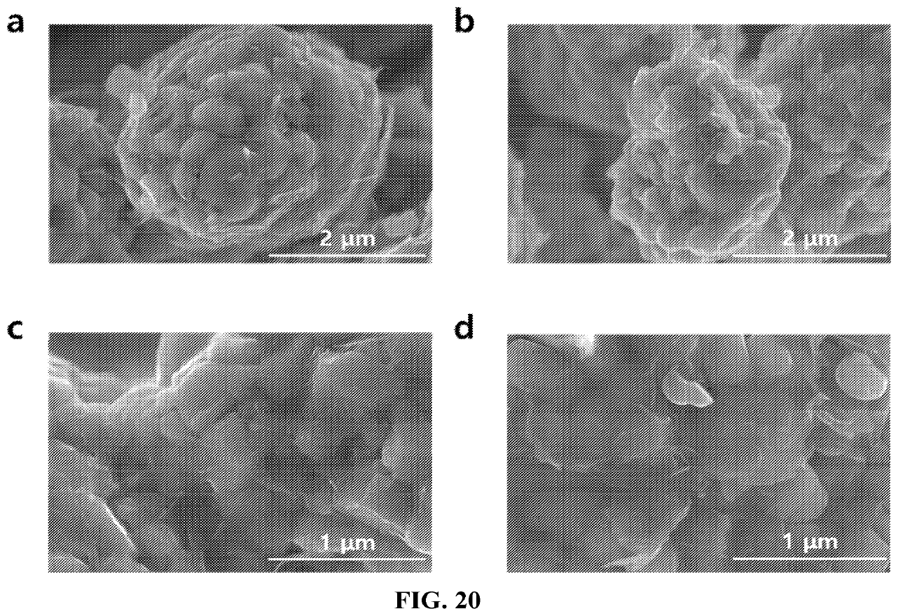

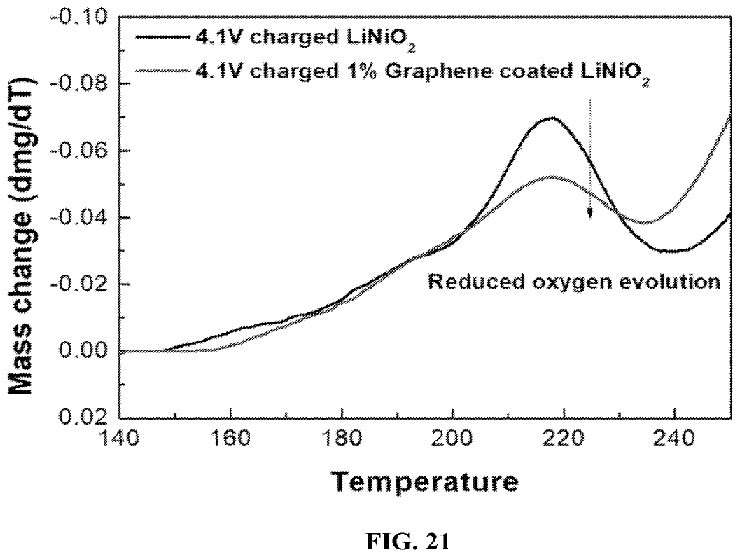

Panel a of FIG. 3 shows the galvanostatic profiles of bare LNO (black) and about 1 wt % graphene-coated LNO (red, G-LNO). The inset SEM image shows that coating the LNO particles with graphene using a Pickering emulsion method yields a surface coating with high conformality (additional SEM images are provided in FIG. 20). An abnormal overpotential exceeding 4.1 V, corresponding to the H2-H3 phase transition region, is observed in the G-LNO profile. The dQ/dV graph and cyclic voltammetry (panel b of FIG. 3) also exhibit this electrochemical response change. Except for this initial anodic overshooting due to the coating, other phase transition regions having O3 stacking were not affected by the presence of graphene. This observation supports the conclusion that the H2-H3 phase transition over 4.1 V, which typically releases oxygen gas and initiates the O1 stacking transition, is affected by the exterior coating. In situ differential electrochemical mass spectrometry (DEMS) directly confirmed that the graphene coating significantly suppresses oxygen gas evolution at high potentials. As shown in panel c of FIG. 3, the bare-LNO electrode releases oxygen gas above 4.1 V and then carbon dioxide over 4.4 V due to electrolyte decomposition, whereas the G-LNO electrode shows no detectable release of oxygen gas and significantly reduced amount of evolved carbon dioxide. Additional experiments on thermally initiated oxygen evolution further support the anti-gassing function of the graphene coating, as shown in FIG. 21.

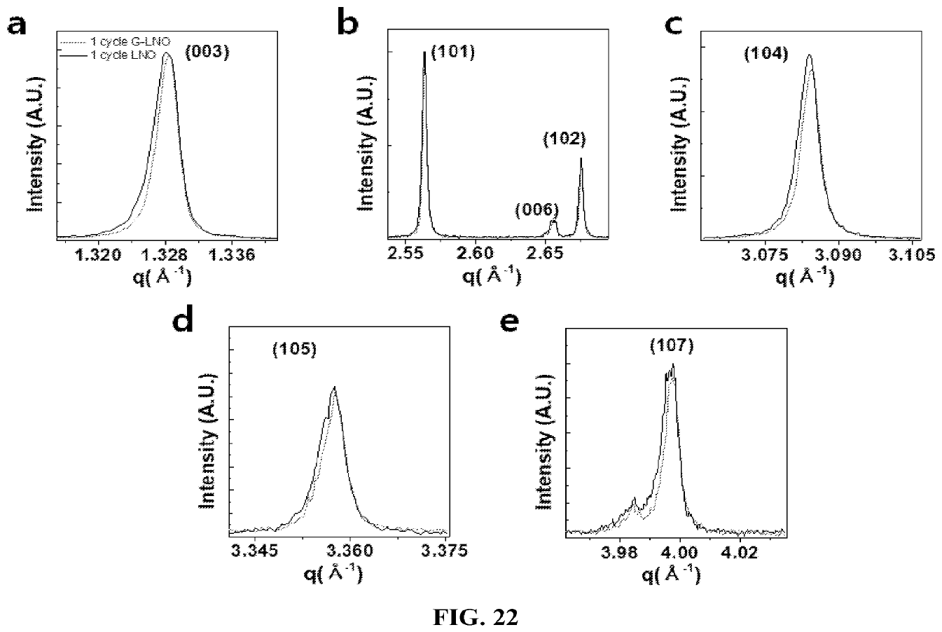

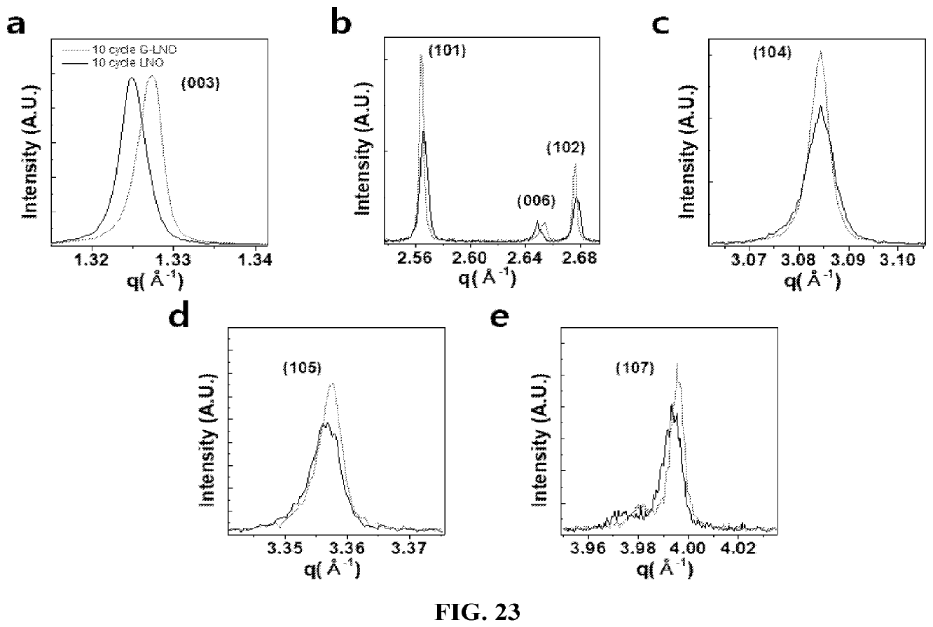

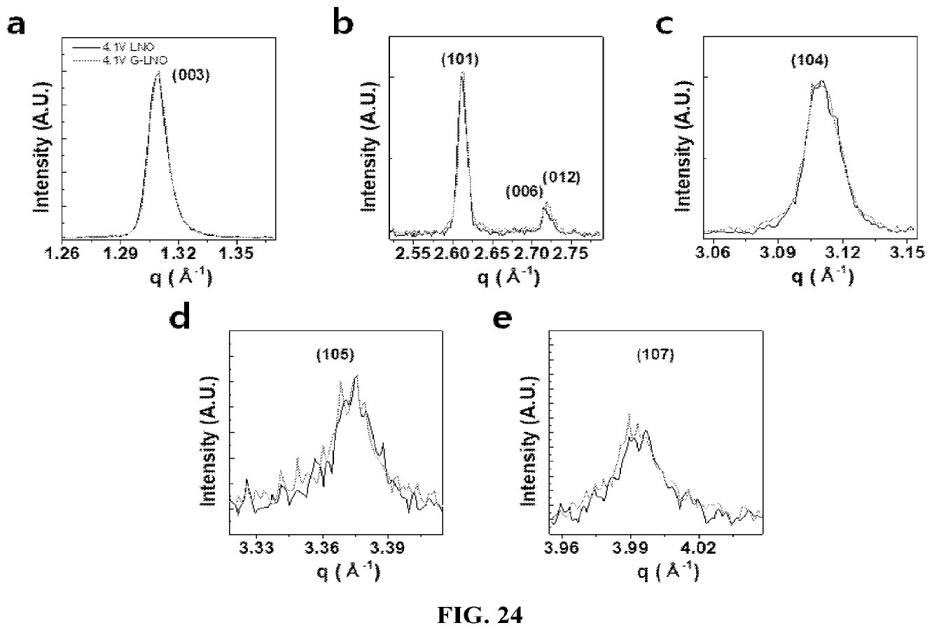

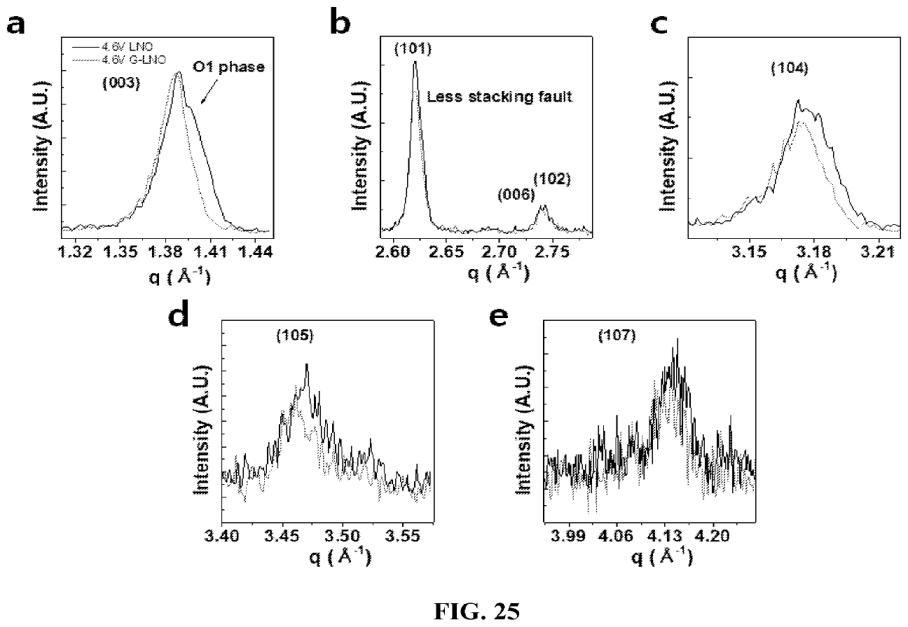

To directly compare the structural stacking change associated with oxygen gas evolution, high-resolution synchrotron XRD is used to assess bare-LNO (black) and G-LNO (red) electrodes after one and ten cycles between 2.8 and 4.6 V. Panel d of FIG. 3 (top) shows the XRD patterns of the bare-LNO and G-LNO electrodes after one cycle. Compared to bare-LNO, the G-LNO electrode exhibited narrower (h0l) peak broadening. Moreover, the intensities of the (101) and (104) peaks are relatively low in the G-LNO electrode, suggesting that the stacking structural evolution is mitigated by suppressed oxygen gas evolution. After ten cycles, the bare-LNO electrode showed serious XRD peak broadening due to accumulated stacking faults and loss of crystallinity, as shown in panel d of FIG. 3 (bottom). In contrast, the G-LNO electrode still maintains its high-quality crystal structure with well-defined XRD peaks, which more details of the XRD peaks are provided in FIGS. 22 and 23. Further comparison of the structural change before gas evolution (about 4.1 V, H2 phase) showed identical XRD patterns for both electrodes as shown in FIG. 24, but the XRD patterns of the H3 phase (4.6 V) exhibited reduced O1 stacking transition for the G-LNO electrode, as shown in FIG. 25.

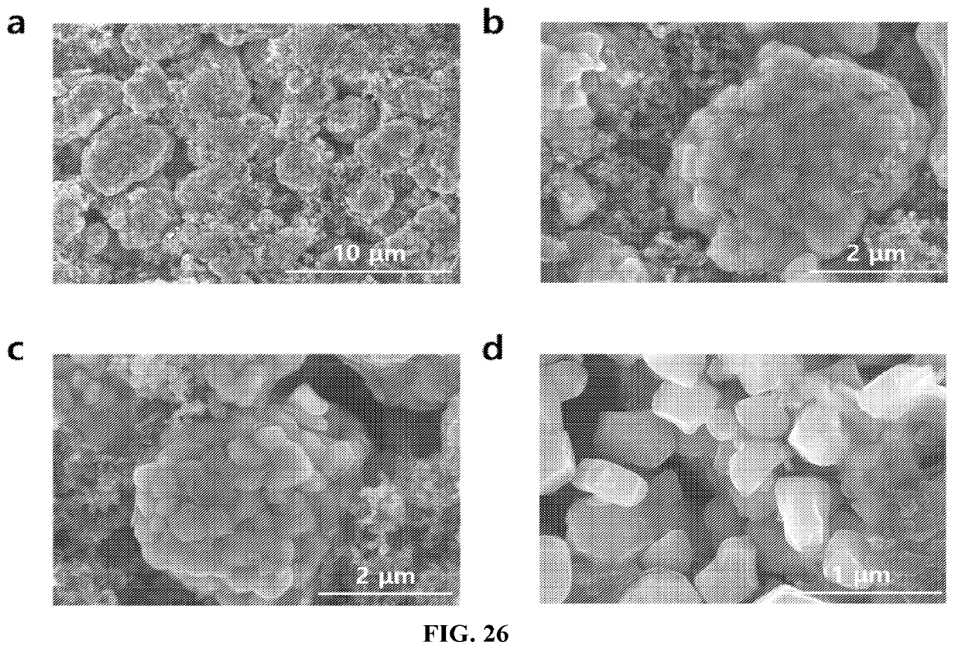

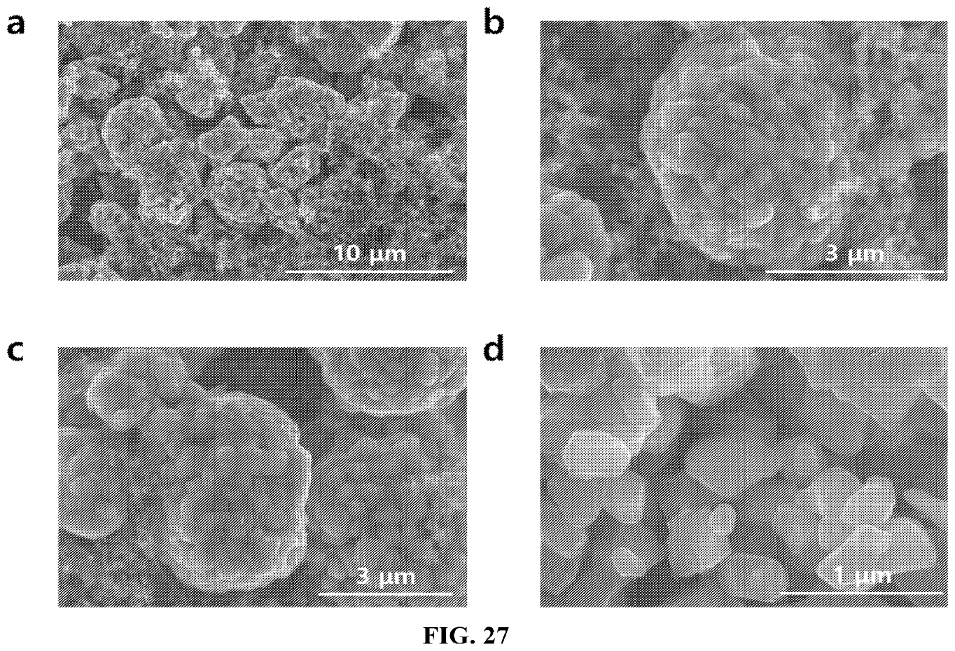

The suppression of the O1 stacking transition enables a significantly improved cycle life of LNO as shown in panels e-f of FIG. 3. Specifically, the G-LNO electrode maintains 95% capacity retention after 50 cycles at C/10 at 4.3 V, whereas bare-LNO only retained 50% of the initial discharge capacity for the same level of cycling. Moreover, the G-LNO electrode showed a 77% capacity retention even at 4.6 V cutoff, whereas bare-LNO exhibited poor capacity retention close to 35% for the same cycling conditions. SEM images of panel g of FIG. 3 show that the secondary particle morphology of G-LNO remained intact unlike bare-LNO (panel a of FIG. 2) after 50 cycles at 4.3 V. After removing the coated graphene from the surface, we confirmed that the extent of creep and cracking in the primary particles is significantly reduced because the exterior coating suppressed the O1 stacking structural evolution, as shown in panel g of FIG. 3 (bottom), with more SEM images provided in FIGS. 16, 26, and 27.

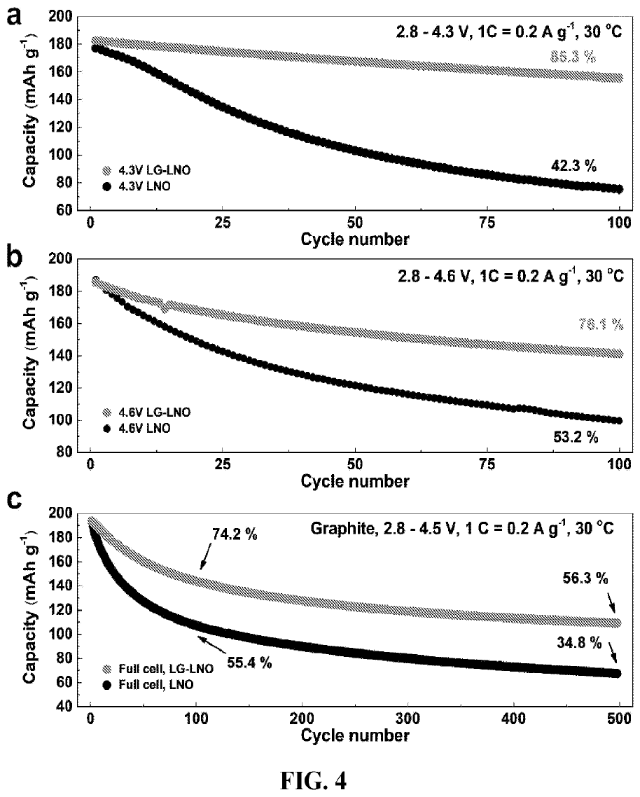

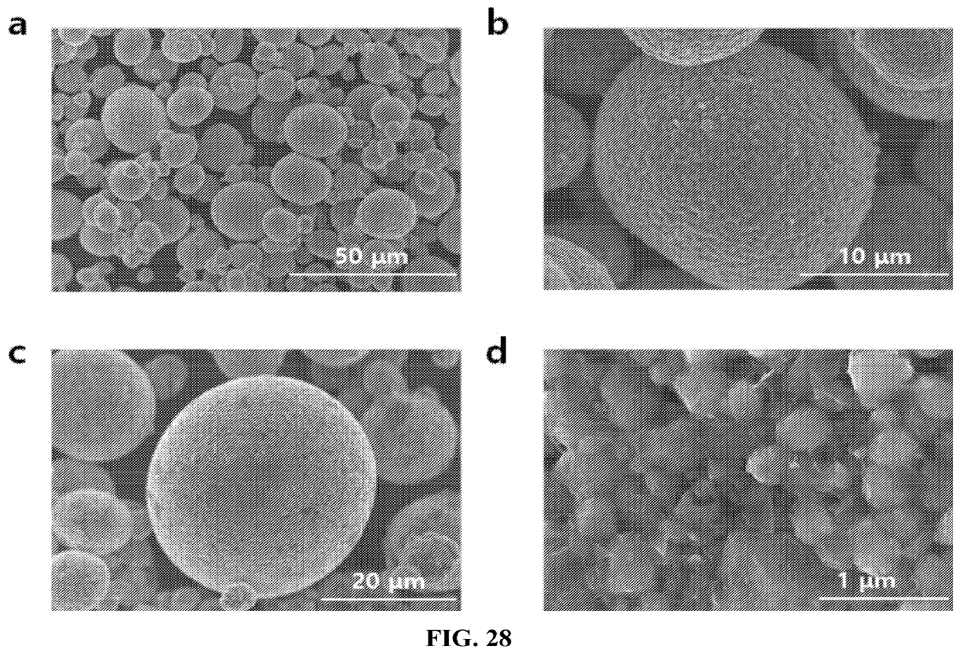

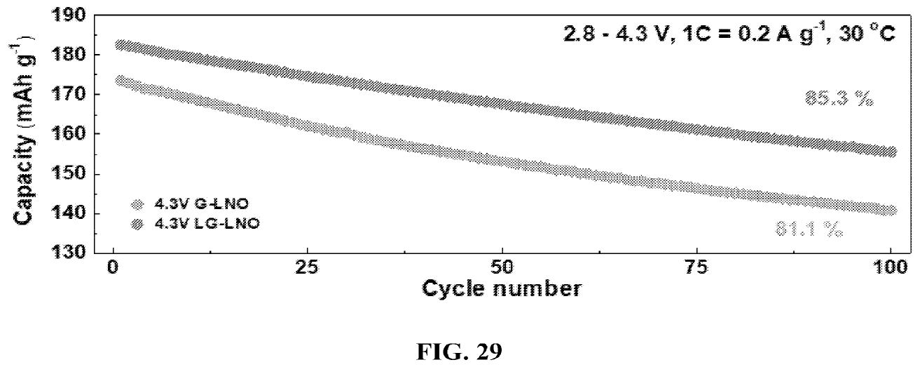

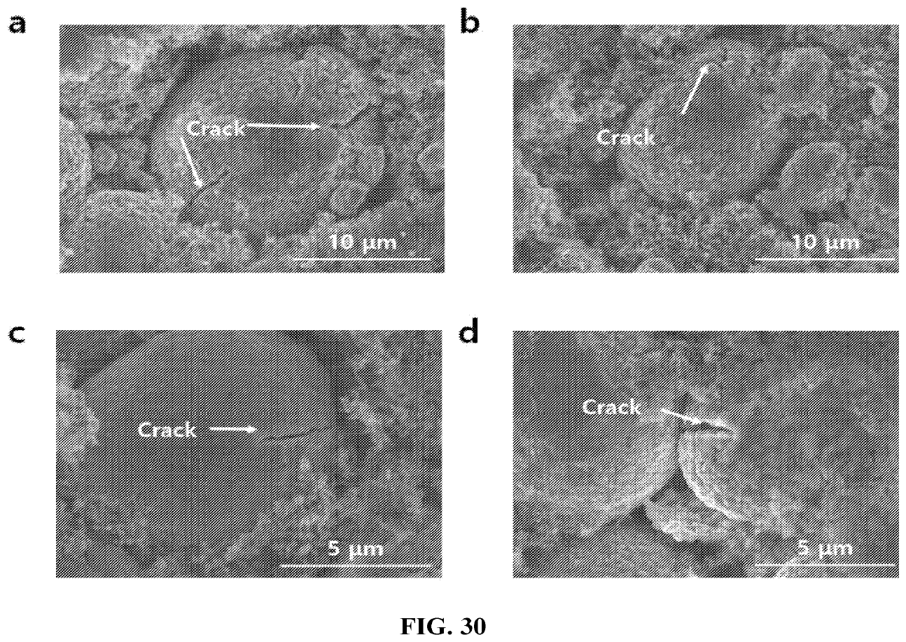

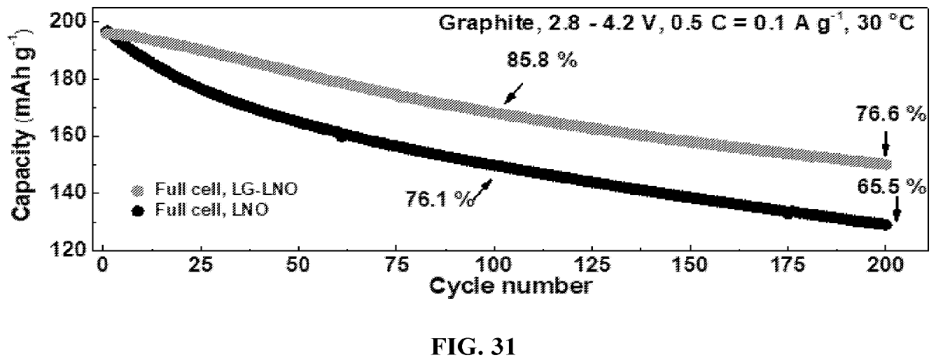

The cycle life is further enhanced by introducing larger LNO particles (over 15 μm) with the exterior graphene coating to minimize the lattice oxygen loss (denoted as LG-LNO, see FIG. 28). As shown in FIG. 29, LG-LNO outperforms the electrochemical stability and rate capability at 4.3 V compared to G-LNO because the reduction in surface area further mitigates oxygen evolution. Panels a-b of FIG. 4 show the cycle life performance at 1C with 4.3 and 4.6 V cutoff voltages, respectively, for control bare-LNO (black) and LG-LNO (red) electrodes. The control electrode maintained only about 40% capacity retention after 100 cycles at 4.3 V, whereas LG-LNO showed a substantial improvement in capacity retention up to 85% under the same cycling conditions, as shown in panel a of FIG. 4. After 100 cycles with a 4.6 V cutoff voltage, the LG-LNO electrodes continued to deliver an improved capacity retention of 76% compared to 53% retention for the control electrode. It should be noted that all electrodes show relatively rapid capacity degradation in the early stages of cycling, which likely results from secondary particles being cracked by c-lattice parameter changes associated with the H2-H3 phase transition at higher current densities, as shown in FIG. 30. Further investigation of the cyclic retention was tested in a graphite full-cell configuration with 4.5 V cutoff voltage. As shown in panel c of FIG. 4, the capacity retention of LG-LNO was 74% while the control electrode showed 55% capacity retention after 100 cycles. After 500 cycles, despite the high cutoff voltage, the capacity of LG-LNO was maintained at over 56%, while the capacity of the control electrode had dropped to only 35%, which more full-cell results are provided in FIG. 31. Therefore, under all testing conditions, the LG-LNO electrodes show a substantial improvement in cycling stability, which can be attributed to the high-voltage degradation cascade being arrested by the conformal graphene coating suppressing oxygen evolution.

### CONCLUSION

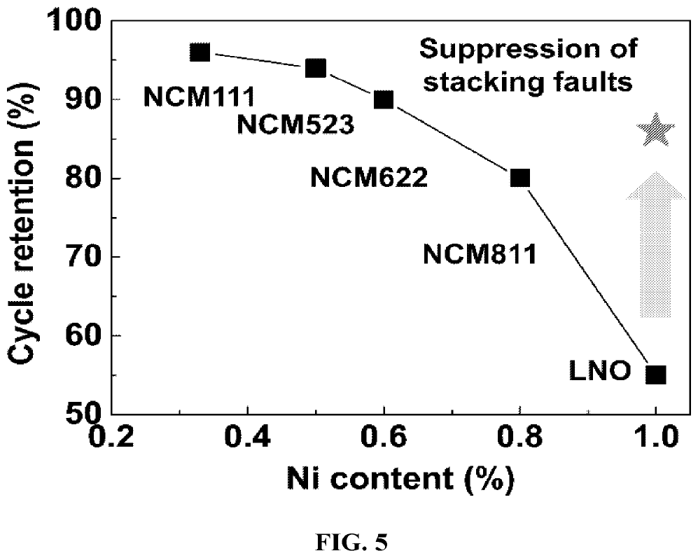

Increasing the Ni content in layered oxide cathodes improves the energy density and reduces the cost of LIBs, but also leads to compromised electrochemical cycle life. LiNiO₂ is the ultimate goal of high-Ni-content layered oxide cathodes with exceptionally high specific and volumetric energy densities in addition to more sustainable and ethical large-scale manufacturing. Nevertheless, the realization of the high-voltage operation of LNO is fundamentally challenging since the single-component Ni composition results in earlier detrimental oxygen stacking changes compared to multi-component layered oxides, ultimately leading to the lowest cycle retention, as shown in FIG. 5. In this exemplary study, we have identified that lattice oxygen loss and the O1 stacking transition are the main reasons for the irreversible capacity loss of LNO when charged to the high-voltage region (up to 4.6 V). Moreover, the appearance of Ni_{Li} defects in the O1 structure diminishes the reversibility of oxygen gliding, resulting in irreversible stacking faults. These stacking structural changes then accelerate mechanical degradation, such as creep, cracking, and even bending of the layered structure due to incoherency of the oxygen framework, causing rapid capacity fade. Consequently, suppression of oxygen evolution is the key factor to realizing stable high-voltage operation of LNO. Consistent with this conclusion, conformal exterior graphene coatings that suppress oxygen evolution mitigate changes in oxygen stacking during electrochemical cycling, resulting in substantially improved capacity retention, as shown in FIG. 5. This detailed mechanistic study thus provides a clear path to enabling high-voltage operation of LNO, which is a key step toward realizing practical high energy density LIBs.

In sum, we successfully mitigate high-voltage degradation cascades associated with oxygen gas evolution and oxygen stacking chemistry with a conformal graphene coating on microscale LNO particles. Lattice oxygen loss is found to play a critical role in the local O3-O1 stacking transition at high states of charge, which subsequently leads to nickel-ion migration and irreversible stacking faults during cycling. This undesirable atomic-scale structural evolution accelerates microscale electrochemical creep, cracking, and even bending of layers, ultimately resulting in macroscopic mechanical degradation of LNO particles. By employing a graphene-based hermetic surface coating, oxygen loss is attenuated in LNO at high states of charge, which suppresses the initiation of the degradation cascade and thus substantially improves the high-voltage capacity retention of LNO.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Armand, M. & Tarascon, J. M. Building better batteries. Nature 451, 652-657 (2008).
[2]. US DRIVE electrochemical energy storage technical team roadmap. (US Council for Automotive Research, 2017).
[3]. Li, W., Erickson, E. M. & Manthiram, A. High-nickel layered oxide cathodes for lithium-based automotive batteries. Nat. Energy 5, 26-34 (2020).
[4]. Kang, K. & Ceder, G. Factors that affect Li mobility in layered lithium transition metal oxides. Phys. Rev. B 74, 094105 (2006).
[5]. Chen, Z., Lu, Z. & Dahn, J. Staging phase transitions in LixCoO₂. J. Electrochem. Soc. 149, A1604 (2002).
[6] Mizushima, K., Jones, P. C., Wiseman, P. J. & Goodenough, J. B. LiₓCoO₂ (0<><1): A new cathode material for batteries of high energy density. Mater. Res. Bull. 15, 783-789 (1980).
[7]. Yoon, C. S., Jun, D.-W., Myung, S.-T. & Sun, Y.-K. Structural stability of LiNiO₂ cycled above 4.2 V. ACS Energy Lett. 2, 1150-1155 (2017).
[8]. Dahn, J. R., von Sacken, U. & Michal, C. A. Structure and electrochemistry of Li_{1±y}NiO₂ and a new Li₂NiO₂ phase with the Ni(OH)₂ structure. Solid State Ionics 44, 87-97 (1990).
[9]. Banza Lubaba Nkulu, C. et al. Sustainability of artisanal mining of cobalt in DR Congo. Nat. Sustain. 1, 495-504 (2018).
[10]. Delmas, C. et al. On the behavior of the LiₓNiO₂ system: an electrochemical and structural overview. J. Power Sources 68, 120-125 (1997).
[11]. Bianchini, M., Fauth, F., Hartmann, P., Brezesinski, T. & Janek, J. An in situ structural study on the synthesis and decomposition of LiNiO₂. J. Mater. Chem. A 8, 1808-1820 (2020).
[12]. Xu, J. et al. Elucidation of the surface characteristics and electrochemistry of high-performance LiNiO₂. Chem. Commun. 52, 4239-4242 (2016).
[13]. Li, H., Zhang, N., Li, J. & Dahn, Updating the structure and electrochemistry of LiₓNiO₂ for 0≤x≤1. J. Electrochem. Soc. 165, A2985 (2018).
[14]. Bianchini, M., Roca-Ayats, M., Hartmann, P., Brezesinski, T. & Janek, J. There and back again—The journey of LiNiO₂ as a cathode active material. Angew. Chem. Int. Ed. 58, 10434-10458 (2019).
[15]. de Biasi, L. et al. Phase transformation behavior and stability of LiNiO₂ cathode material for Li-ion batteries obtained from in situ gas analysis and operando X-ray diffraction. ChemSusChem 12, 2240-2250 (2019).
[16]. Bi, Y. et al. Reversible planar gliding and microcracking in a single-crystalline Ni-rich cathode. Science 370, 1313-1317 (2020).
[17]. Xu, C. et al. Bulk fatigue induced by surface reconstruction in layered Ni-rich cathodes for Li-ion batteries. Nat. Mater. 20, 84-92 (2020).
[18]. Kondrakov, A. O. et al. Anisotropic lattice strain and mechanical degradation of high- and low-nickel NCM cathode materials for Li-ion batteries. J. Phys. Chem. C 121, 3286-3294 (2017).
[19]. Sun, H.-H. & Manthiram, A. Impact of microcrack generation and surface degradation on a nickel-rich layered Li[Ni_{0.9}Co_{0.05}Mn_{0.05}]O2 cathode for lithium-ion batteries. Chem. Mater. 29, 8486-8493 (2017).
[20]. Song, S. H. et al. High-voltage-driven surface structuring and electrochemical stabilization of Ni-rich layered cathode materials for Li rechargeable batteries. Adv. Energy Mater. 10, 2000521 (2020).
[21]. Wandt, J., Freiberg, A. T. S., Ogrodnik, A. & Gasteiger, H. A. Singlet oxygen evolution from layered transition metal oxide cathode materials and its implications for lithium-ion batteries. Mater. Today 21, 825-833 (2018).
[22]. Kong, F. et al. Kinetic stability of bulk LiNiO₂ and surface degradation by oxygen evolution in LiNiO₂-based cathode materials. Adv. Energy Mater. 9, 1802586 (2019).
[23]. Xu, J. et al. Understanding the degradation mechanism of lithium nickel oxide cathodes for Li-ion batteries. ACS Appl. Mater. Interfaces 8, 31677-31683 (2016).
[24]. Sun, H. H. et al. Beyond doping and coating: prospective strategies for stable high-capacity layered Ni-rich cathodes. ACS Energy Lett. 5, 1136-1146 (2020).
[25]. Yoon, C. S. et al. Self-passivation of a LiNiO₂ cathode for a lithium-ion battery through Zr doping. ACS Energy Lett. 3, 1634-1639 (2018).
[26]. Yoon, C. S. et al. Cation ordering of Zr-doped LiNiO₂ cathode for lithium-ion batteries. Chem. Mater. 30, 1808-1814 (2018).
[27]. Yang, J. & Xia, Y. Suppressing the phase transition of the layered Ni-rich oxide cathode during high-voltage cycling by introducing low-content LiₓMnO₃. ACS Appl. Mater. Interfaces 8, 1297-1308 (2016).
[28]. Ohzuku, T., Ueda, A. & Nagayama, M. Electrochemistry and structural chemistry of LiNiO₂ (R3m) for 4 volt secondary lithium cells. J. Electrochem. Soc. 140, 1862-1870 (1993).
[29]. Delmas, C. et al. Lithium batteries: a new tool in solid state chemistry. Int. J. Inorg. Mater. 1, 11-19 (1999).
[30]. Croguennec, L., Pouillerie, C. & Delmas, C. Structural characterisation of new metastable NiO₂ phases. Solid State Ionics 135, 259-266 (2000).
[31]. Tarascon, J. M. et al. In situ structural and electrochemical study of Ni₁₋ₓCoₓO₂ metastable oxides prepared by soft chemistry. J. Solid State Chem. 147, 410-420 (1999).
[32]. Radin, M. D., Alvarado, J., Meng, Y. S. & Van der Ven, A. Role of crystal symmetry in the reversibility of stacking-sequence changes in layered intercalation electrodes. Nano Lett. 17, 7789-7795 (2017).
[33]. Treacy, M. M. J., Newsam, J. M. & Deem, M. W. A general recursion method for calculating diffracted intensities from crystals containing planar faults. Proc. R. Soc. A 433, 499-520 (1991).
[34]. Van der Ven, A., Aydinol, M. K. & Ceder, G. First-principles evidence for stage ordering in LiₓCoO₂. J. Electrochem. Soc. 145, 2149-2155 (1998).
[35]. Arroyo y de Dompablo, M. E., Van der Ven, A. & Ceder, G. First-principles calculations of lithium ordering and phase stability on LiₓNiO₂. Phys. Rev. B 66, 064112 (2002).
[36]. Croguennec, L., Pouillerie, C., Mansour, A. N. & Delmas, C. Structural characterisation of the highly deintercalated LiₓNi_{1.02}O₂ phases (with x≤ 0.30). J. Mater. Chem. 11, 131-141 (2001).
[37]. Zou, L. et al. The role of secondary particle structures in surface phase transitions of Ni-rich cathodes. Chem. Mater. 32, 2884-2892 (2020).
[38]. Kim, D. et al. Efficient, stable silicon tandem cells enabled by anion-engineered wide-bandgap perovskites. Science 368, 155-160 (2020).
[39]. Alvarado, J. et al. Improvement of the cathode electrolyte interphase on P2-Na_{2/3}Ni_{1/3}Mn_{2/3}O₂ by atomic layer deposition. ACS Appl. Mater. Interfaces 9, 26518-26530 (2017).
[40]. Zhang, H. et al. Rock-salt growth-induced (003) cracking in a layered positive electrode for Li-ion batteries. ACS Energy Lett. 2, 2607-2615 (2017).
[41]. Jung, S.-K. et al. Understanding the degradation mechanisms of LiNi_{0.5}Co_{0.2}Mn_{0.3}O₂ cathode material in lithium ion batteries. Adv. Energy Mater. 4, 1300787 (2014).
[42]. Mu, L. et al. Oxygen release induced chemomechanical breakdown of layered cathode materials. Nano Lett. 18, 3241-3249 (2018).
[43]. Cheng, T. et al. Achieving stable cycling of LiCoO2 at 4.6 V by multilayer surface modification. Adv. Funct. Mater. 31, 2001974 (2021).
[44]. Park, K.-Y. et al. Concurrently approaching volumetric and specific capacity limits of lithium battery cathodes via conformal pickering emulsion graphene coatings. Adv. Energy Mater. 10, 2001216 (2020).
[45]. Sharifi-Asl, S. et al. Anti-oxygen leaking LiCoO₂. Adv. Funct. Mater. 29, 1901110 (2019).
[46]. Barthel, J. Dr. Probe: A software for high-resolution STEM image simulation. Ultramicroscopy 193, 1-11 (2018).
[47]. Kresse, G. & Furthmüller, J. Efficiency of ab-initio total energy calculations for metals and semiconductors using a plane-wave basis set. Comput. Mater. Sci. 6, 15-50 (1996).
[48]. Perdew, J. P. et al. Restoring the density-gradient expansion for exchange in solids and surfaces. Phys. Rev. Lett. 100, 136406 (2008).
[49]. Das, H., Urban, A., Huang, W. & Ceder, G. First-principles simulation of the (Li—Ni-vacancy) O phase diagram and its relevance for the surface phases in Ni-rich Li-ion cathode materials. Chem. Mater. 29, 7840-7851 (2017).
[50]. Hart, G. L. & Forcade, R. W. Algorithm for generating derivative structures. Phys. Rev. B 77, 224115 (2008).
[51]. Noh, H.-J., Youn, S., Yoon, C. S. & Sun, Y.-K. Comparison of the structural and electrochemical properties of layered Li[NiₓCo_{y}Mn_{z}]O₂ (x=1/3, 0.5, 0.6, 0.7, 0.8 and 0.85) cathode material for lithium-ion batteries. J. Power Sources 233, 121-130 (2013).
[52]. Suppressing detrimental phase transitions via tungsten doping of LiNiO₂ cathode for next-generation lithium-ion batteries, J. Mater. Chem. A, 2019, 7, 18580-18588.
[53]. Self-Passivation of a LiNiO₂ Cathode for a Lithium-Ion Battery through Zr Doping, ACS Energy Lett. 2018, 3, 7, 1634-1639.
[54]. Cation Ordering of Zr-Doped LiNiO₂ Cathode for Lithium-Ion Batteries, Chem. Mater. 2018, 30, 5, 1808-1814.
[55]. Complementary Effects of Mg and Cu Incorporation in Stabilizing the Cobalt-Free LiNiO₂ Cathode for Lithium-Ion Batteries, ACS Appl. Mater. Interfaces 2020, 12, 39, 43653-43664.
[56]. Effect of Mg-doping on the degradation of LiNiO₂-based cathode materials by combined spectroscopic methods, J. Power Sources, 2012, 205, 1, 449-455.
[57]. Structure and primary particle double-tuning by trace nano-TiO₂ for a high-performance LiNiO₂ cathode material, Sustainable Energy Fuels, 2019, 3, 3234-3243.
[58]. Role of V₂O₅ coating on LiNiO₂-based materials for lithium ion battery, J. Power Sources, 2014, 245, 183-193.
[59]. Understanding Co roles towards developing Co-free Ni-rich cathodes for rechargeable batteries, Nat. Energy, 2021 6, 277-286.
[60]. Gradient coated LiNiO₂ material and preparation method (2013) CN103078109A.
[61]. Graphene-enhanced cathode materials for lithium batteries (2010) U.S. Pat. No. 8,691,441B2.
[62]. Nano graphene reinforced nanocomposite particles for lithium battery electrodes (2008) US20100143798A1.
[63]. Comprehensive Enhancement of Nanostructured Lithium-Ion Battery Cathode Materials via Conformal Graphene Dispersion (2017) Nano Letters, 17, 4, 2539-2546.

1. A composite for improving electrochemical stability of an electrochemical device, comprising:
graphene; and
an electrode active material having microscale particles, wherein said microscale particles are conformally coated by said graphene.

2. The composite of claim 1, wherein said microscale particles have an average size of about 1 μm or larger than 1 μm.

3. The composite of claim 1, wherein each of said microscale particles is uniformly and conformally coated with said graphene.

4. The composite of claim 1, wherein each of said microscale particles is coated with amorphous carbon with sp²-carbon content along with said graphene.

5. The composite of claim 1, wherein a ratio of said graphene to said cathode active material is in a range from about 0.05-10 wt %.

6. The composite of claim 1, wherein said graphene comprises solution-exfoliated graphene.

7. The composite of claim 1, further comprising amorphous carbon with sp²-carbon content.

8. The composite of claim 7, wherein the amorphous carbon is an annealation product of cellulose polymers.

9. The composite of claim 8, being formed by annealing a mixture of said electrode active material, said graphene, and ethyl cellulose at a temperature for a period of time to decompose the ethyl cellulose, thereby resulting in said composite having said annealation product of the ethyl cellulose.

10. The composite of claim 1, wherein said electrode active material comprises a cathode active material or an anode active material.

11. The composite of claim 10, wherein said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O2 (x>0.6).

12. The composite of claim 10, wherein said anode active material comprises Si, SiOₓ, Co₃O₄, MnO₂, and/or other conversion type anode materials.

13. An electrode for an electrochemical device, comprising:
a composite comprising graphene, and an electrode active material having microscale particles, wherein said microscale particles are conformally coated by said graphene.

14. The electrode of claim 13, wherein each of said microscale particles is uniformly and conformally coated with said graphene.

15. The electrode of claim 13, wherein each of said microscale particles is coated with amorphous carbon with sp²-carbon content along with said graphene.

16. The electrode of claim 13, wherein a ratio of said graphene to said cathode active material is in a range from about 0.05-10 wt % in said composite.

17. The electrode of claim 13, wherein said graphene comprises solution-exfoliated graphene.

18. The electrode of claim 13, wherein said composite further comprises amorphous carbon with sp²-carbon content.

19. The electrode of claim 18, wherein the amorphous carbon is an annealation product of cellulose polymers.

20. The electrode of claim 19, wherein said composite is formed by annealing a mixture of said electrode active material, said graphene, and ethyl cellulose at a temperature for a period of time to decompose the ethyl cellulose, thereby resulting in said composite having said annealation product of the ethyl cellulose.

21. The electrode of claim 13, wherein said electrode active material comprises a cathode active material or an anode active material.

22. The electrode of claim 21, wherein said anode active material comprises Si, SiOₓ, Co₃O₄, MnO₂, and/or other conversion type anode materials.

23. The electrode of claim 21, wherein said cathode active material comprises LiNiO₂ (LNO), LiCoO₂, LiNi_{0.8}Co_{0.15}Al_{0.05}O₂, and/or other Ni-rich layered oxides including LiNiₓMn_{y}Co_{z}Al_{1-x-y-z}O2 (x>0.6).

24. The electrode of claim 23, wherein said electrode has an abnormal overpotential exceeding 4.1 V, corresponding to an H2-H3 phase transition region.

25. The electrode of claim 23, wherein said graphene coating significantly suppresses oxygen gas evolution at high potentials over 4.1 V.

26. The electrode of claim 23, wherein said electrode has narrower (h0l) peak broadening.

27. The electrode of claim 23, wherein said electrode has intensities of (101) and (104) peaks that are relatively low, so that the stacking structural evolution is mitigated by suppressed oxygen gas evolution.

28. The electrode of claim 23, wherein after ten cycles, said electrode still maintains its high-quality crystal structure with well-defined XRD peaks.

29. The electrode of claim 28, wherein the XRD patterns of the H3 phase exhibits reduced O1 stacking transition or O1 stacking faults for said electrode.

30. The electrode of claim 23, wherein said electrode maintains 95% capacity retention after 50 cycles at C/10 at 4.3 V.

31. The electrode of claim 23, wherein said electrode has a 77% capacity retention even at 4.6 V cutoff.

32. The electrode of claim 23, wherein the microscale particle morphology of said composite remains intact after 50 cycles at 4.3 V.

33. The electrode of claim 23, wherein said microscale particles have an average size of about 1 μm or larger than 1 μm.

34. The electrode of claim 33, wherein said microscale particles are larger LNO particles (LG-LNO) having the average size of about 15 μm or larger than 15 μm.

35. The electrode of claim 34, wherein said LG-LNO electrode has a substantial improvement in capacity retention up to 85% after 100 cycles at 4.3 V.

36. The electrode of claim 34, wherein after 100 cycles with a 4.6 V cutoff voltage, said LG-LNO electrode continues to deliver an improved capacity retention of 76%.

37. The electrode of claim 34, wherein said LG-LNO electrode show a substantial improvement in cycling stability, which is attributed to the high-voltage degradation cascade being arrested by the conformal graphene coating suppressing oxygen evolution.

38. An electrochemical device, comprising the electrode of claim 13.

39. The electrochemical device of claim 38, being a battery.

40. A method for forming a composite, comprising:
providing an electrode active material having microscale particles; and
coating said microscale particles conformally with a hermetic layer of graphene.

41. The method of claim 40, wherein said graphene comprises solution-exfoliated graphene.

42. The method of claim 40, wherein said coating comprises
forming a mixture of said electrode active material graphene, and ethyl cellulose in a solvent to disperse said electrode active material and said graphene with the ethyl cellulose; and
annealing the agitated mixture at a temperature for a period of time to decompose the ethyl cellulose, thereby resulting in said composite.

43. The method of claim 42, wherein each of said microscale particles is coated with amorphous carbon with sp²-carbon content along with said graphene.

44. The method of claim 40, wherein said coating is performed by a Pickering emulsion method.

45. The method of claim 40, wherein said microscale particles have an average size of about 1 μm or larger than 1 μm.

46. The method of claim 40, wherein a ratio of said graphene to said cathode active material is in a range from about 0.05-10 wt %.
